(19) United States
(12) Patent Application Publication
(10) Pub. No.: US 2026/0288776 A1
(43) Pub. Date: Sep. 24, 2026

(54) SYSTEM

(71) Applicant: SoftBank Group Corp., Tokyo (JP)

(72) Inventor: Toshimitsu KUGIMOTO, Tokyo (JP)

(73) Assignee: SoftBank Group Corp., Tokyo (JP)

(21) Appl. No.: 19/567,327

(22) Filed: Mar. 16, 2026

(30) Foreign Application Priority Data
Mar. 19, 2025 (JP) 2025-045046

(51) Int. Cl. G06F 16/332; G06F 40/253; G06F 40/284; G06F 40/35; G06F 40/40; G10L 13/02

(52) U.S. Cl. CPC G06F 16/3326; G06F 40/35; G06F 40/40; G10L 13/02; G06F 40/253; G06F 40/284

(57) ABSTRACT

A system includes a processor that is configured to perform natural language processing to analyze a question from a user, access a database to obtain financial information of the user, generate a prompt for instructing a generative artificial intelligence model to generate an optimal answer, and generate the answer by providing the prompt as input to the generative artificial intelligence model.

### CROSS-REFERENCE TO RELATED APPLICATION

This application is based on and claims priority under 35 USC 119 from Japanese Patent Application No. 2025-045046 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional financial advisory systems and personal finance management tools suffer from several limitations. In many cases, the systems provide only rule-based or template-based responses that cannot flexibly adapt to diverse, natural-language questions from users. As a result, the systems often fail to provide answers that are sufficiently tailored to the specific financial situation, objectives, and constraints of each individual user. Furthermore, conventional systems generally do not fully leverage up-to-date user financial information stored in various databases, and therefore are unable to generate context-aware, data-driven advice.

In addition, while generative artificial intelligence models have recently become available, typical integrations of such models in financial applications do not adequately control or structure the interaction with the models. Consequently, the generated answers may lack consistency, may not sufficiently incorporate financial expertise, or may not appropriately reflect domain-specific knowledge. As a result, users may receive answers that are incomplete, not aligned with best practices in financial management, or difficult to trust in actual decision-making.

Moreover, existing systems do not sufficiently provide personalized proposals for improving the user's financial management based on detailed analysis of the user's financial data. Many tools merely visualize income and expenses without transforming this information into actionable, expert-informed recommendations for saving, investing, or balancing budgets. Therefore, there is a need for a system that can interpret natural-language questions, access user financial information, control a generative artificial intelligence model through appropriate prompts, and deliver expert-informed, personalized answers and proposals to improve the user's financial management.

### SUMMARY

In order to solve the above-described problems, a system according to one aspect of the present invention comprises a processor, wherein the processor is configured to perform natural language processing to analyze a question from a user. By performing such natural language processing, the processor interprets the intent and content of free-form questions entered by the user, thereby enabling flexible handling of various queries related to financial management, investment, saving, and other topics.

The processor is further configured to access a database to obtain financial information of the user, such as transaction histories, account balances, income records, and expenditure patterns. By retrieving this financial information, the processor can ground the analysis and responses in actual, up-to-date data, thereby enabling personalized and context-aware advice.

The processor is also configured to generate a prompt for instructing a generative artificial intelligence model to generate an optimal answer, and to generate the answer by providing the prompt as input to the generative artificial intelligence model. The prompt is constructed based on the analyzed user question and the obtained financial information, and is designed to control the behavior of the generative artificial intelligence model so that the model produces an answer that is relevant, specific, and aligned with the user's financial situation.

In one embodiment, the processor is configured to operate under supervision of an expert and to reflect knowledge of the expert in generation of the prompt and in generation of the answer. For example, financial experts may define rules, templates, or guidelines that the processor incorporates when constructing prompts, thereby embedding domain knowledge and best practices in the interaction with the generative artificial intelligence model. As a result, the generated answers can more reliably reflect professional financial expertise.

In another embodiment, the processor is configured to analyze the financial information of the user and to provide a proposal regarding financial management in order to improve financial management of the user. The processor may, for example, identify spending patterns, detect potential saving opportunities, or evaluate the user's progress toward financial goals, and then generate concrete proposals for budget adjustments, saving strategies, or investment allocations. By combining natural language processing, database access, prompt generation for the generative artificial intelligence model, and expert-informed analysis, the system according to the present invention can provide highly personalized and reliable financial advice that addresses the above-mentioned problems.

The term “processor” refers to one or more hardware processing units, such as a central processing unit (CPU), a graphics processing unit (GPU), a digital signal processor (DSP), or any combination thereof, that is configured to execute instructions for implementing functions of the system.

The term “natural language processing” refers to a series of computational techniques for analyzing, understanding, or processing text or speech expressed in a human language, including but not limited to tokenization, syntactic analysis, semantic analysis, intent detection, and entity extraction.

The term “question from a user” refers to a natural-language input, such as a sentence, phrase, or utterance, that is provided by the user to the system and that requests information, advice, or an explanation, particularly in relation to financial matters.

The term “database” refers to any structured or unstructured data storage system, including relational databases, NoSQL databases, data warehouses, or other persistent storage, that stores financial information or related data accessible by the processor.

The term “financial information of the user” refers to data associated with the user's financial status and behavior, including but not limited to transaction histories, account balances, income records, expenditure records, investment holdings, liabilities, and financial goals.

The term “generative artificial intelligence model” refers to a machine learning model that is configured to generate text, numerical outputs, or other content in response to input data, and that is trained using large-scale data sets, such as a large language model or other generative model architecture.

The term “prompt” refers to a structured or unstructured input text or data sequence that is provided to the generative artificial intelligence model to instruct the model regarding a task, context, constraints, or desired format of an answer.

The term “optimal answer” refers to an answer generated by the system that is intended to be appropriate, relevant, and useful for the user's question and financial situation, taking into account the available financial information, expert knowledge, and system-defined criteria.

The term “expert” refers to a person or a group of persons having specialized knowledge or professional experience in finance, investment, accounting, or a related field, whose knowledge is used to guide or supervise the operation of the system.

The term “operate under supervision of an expert” refers to a mode of operation in which the processor utilizes rules, guidelines, configurations, review processes, or other inputs defined or approved by the expert to influence the generation of prompts and answers.

The term “knowledge of the expert” refers to domain-specific information, rules, heuristics, policies, best practices, evaluation criteria, or other expertise provided by the expert and used by the processor in generating prompts and answers.

The term “proposal regarding financial management” refers to a recommendation, suggestion, or plan generated by the system that relates to managing the user's finances, including but not limited to saving strategies, budgeting, investment allocation, expense reduction, or debt management.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

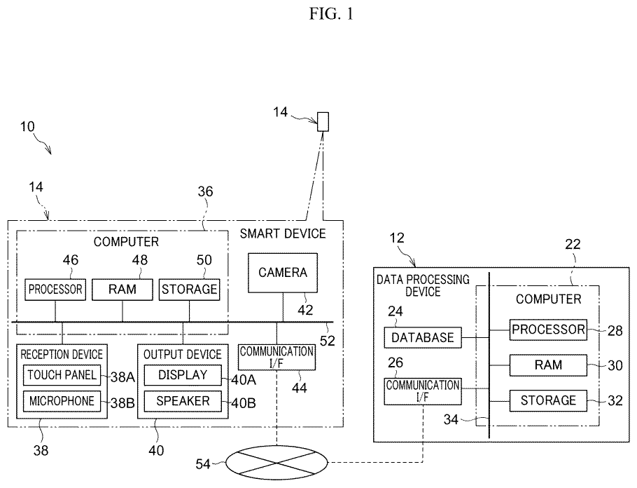

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

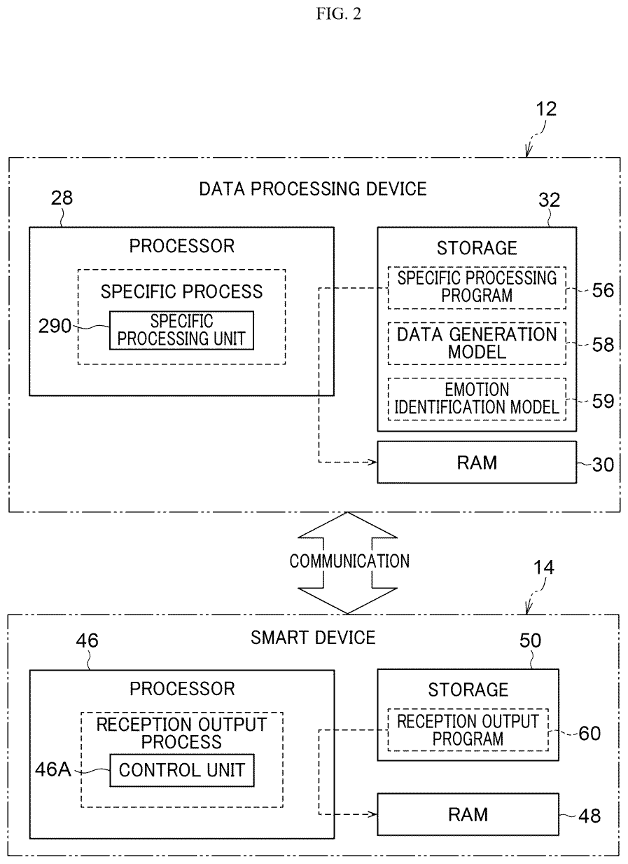

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented financial advisory systems typically rely on static rule engines or manually designed templates to generate responses to user inquiries. In such systems, a processor often applies predefined decision trees or fixed text fragments to user inputs, without deeply analyzing the natural-language content of user questions or dynamically adapting the advice to the user's detailed financial attributes. As a result, these systems exhibit several technical limitations.

First, the processor in conventional systems is not configured to perform fine-grained natural language analysis of user inputs in coordination with structured financial attribute data. User questions such as “How should I invest my surplus funds this month?” or “Is it better to buy a car in cash or with a loan?” are often processed only as keyword matches. This simplistic processing causes a technical mismatch between the unstructured, context-rich natural language input and the rigid data structures used for financial calculation, leading to inefficient use of computational resources and low-quality, generic outputs.

Second, even when a generative AI model is employed as a computational engine, conventional integrations often submit user questions directly to the model or use minimal context. The processor sends only a raw question or a simplistic prompt, without systematically embedding structured financial attribute information, system-level constraints, or expert-derived evaluation criteria. This leads to suboptimal utilization of the generative AI model's computation, because the model must implicitly infer user context from incomplete or noisy input. Consequently, server resources are spent on repeated clarification and long responses that are not effectively constrained, creating unnecessary network traffic and processing overhead.

Third, existing systems do not provide a processor architecture that programmatically structures and constrains the prompt sentence in a manner that reliably reflects expert knowledge, risk explanation requirements, and comparison viewpoints. This lack of a structured prompt generation mechanism results in unstable output quality, difficulties in compliance control, and challenges in consistently enforcing disclaimers and other mandatory notices at the system level. From a computer-technology perspective, this undermines the reliability and controllability of the generative AI model integration, and hampers the ability of the server to consistently generate machine-usable, well-formed output data for client devices.

Fourth, conventional systems generally treat the generative AI model's output as a final text to be displayed, without performing additional computational analysis to derive quantitative indicators such as saving ratios, debt burdens, asset allocation statuses, or investment risk levels. Because of this, the processor does not leverage the generated information to compute structured metrics for downstream processing, such as automated household-budget evaluation or dynamic policy generation. This results in a system that is text-centric, with limited capability to drive further automated financial management functions.

Therefore, there is a need for a computer-implemented system in which a processor is specifically configured to: (i) analyze natural language input from a user to extract an intention and financial-related elements; (ii) access structured financial attribute information from a storage device; (iii) generate a structured, constraint-aware prompt sentence that combines the extracted intention, the financial attribute information, and expert-derived rule information; (iv) supply the prompt sentence to a generative AI model to efficiently generate text-based answer information; (v) post-process the answer information by appending mandatory cautionary or disclaimer text and formatting the answer into a consistent output structure; and (vi) compute additional quantitative financial indicators and policy suggestions based on both the stored financial attributes and the generated answer information. By providing such a processor configuration, the present invention improves the way computing resources are used to transform unstructured natural language queries and structured financial data into reliable, machine-controlled, and user-presentable output, thereby improving the underlying computer technology for personalized financial advisory services.

The specific processing by the specific processing unit 290 of the data processing device 12 in Example 1 is realized by the following means.

The present invention provides a server comprising a processor and a storage device, the processor being configured to execute computer-readable instructions that cause the processor to perform operations including: receiving, from a terminal operated by a user via a communication network, input information expressed in natural language and including a question regarding financial matters; analyzing the input information by a natural language processing function to extract an intention of the user and financial-related elements including at least one of an investment purpose, a time horizon, or a risk preference; accessing the storage device that stores structured financial attribute information associated with an identifier of the user, and acquiring, based on the identifier, the financial attribute information including at least one of income information, asset information, liability information, investment experience information, surplus fund information, or risk tolerance information; generating a prompt sentence by combining the extracted intention and financial-related elements, the acquired financial attribute information, and constraint conditions regarding at least one of an answer format, a level of explanation, or a description of risk, and preparing the prompt sentence as input data for a generative information processing model; transmitting the generated prompt sentence to an internal or external generative information processing model, causing the generative information processing model to perform numerical computation based on the prompt sentence to generate answer information in a text format, and acquiring the generated answer information as response data; post-processing the acquired answer information by adding predetermined cautionary text or disclaimer text and formatting the answer information into output information suitable for presentation to the user; calculating, based on at least the acquired financial attribute information and optionally the acquired answer information, at least one quantitative financial indicator including a saving ratio, a debt repayment burden, an asset allocation status, or an investment risk level, and generating proposal information regarding financial management including at least one of a household budget improvement policy, an expenditure reduction policy, or an asset allocation policy according to a result of the calculation; and transmitting the formatted output information including the proposal information to the terminal so that the terminal displays the formatted output information to the user. This enables the server-side computing architecture to more efficiently and reliably transform unstructured natural language input and structured financial data into constrained, expert-informed prompt sentences for the generative information processing model, to obtain stable and policy-compliant answer information, and to further derive structured quantitative indicators and management proposals, thereby improving the technical functioning of the computer system in providing personalized financial advisory output to user terminals.

The term “processor” refers to a hardware or virtual processing unit, such as a central processing unit or a programmable logic device, configured to execute computer-readable instructions to perform the functions described for the server.

The term “storage device” refers to a computer-accessible memory apparatus, such as a semiconductor memory, magnetic storage, optical storage, or a combination thereof, that stores structured or unstructured data including financial attribute information, rule information, and program instructions.

The term “terminal” refers to an information processing apparatus operated by a user, such as a mobile communication device, a personal computer, or a tablet device, that is configured to transmit input information to the server and to display output information received from the server.

The term “input information” refers to data received from the terminal, including natural language text that expresses a user's question or request regarding financial matters, and optionally including identifiers, metadata, or additional parameters associated with the user.

The term “natural language processing function” refers to a software-implemented procedure executed by the processor for analyzing text expressed in human language, including at least one of tokenization, part-of-speech tagging, syntactic parsing, keyword extraction, or entity recognition, to derive structured representations from the text.

The term “intention” refers to an inferred purpose, objective, or request of the user, determined by the natural language processing function from the input information, such as a desire to invest surplus funds, evaluate a purchase option, or optimize financial management.

The term “financial-related elements” refers to information items extracted from the input information that pertain to financial context, including at least one of investment purpose, time horizon, risk preference, target amount, or type of financial transaction.

The term “identifier” refers to data that uniquely or pseudo-uniquely associates the input information with a particular user record in the storage device, such as a user ID, account ID, or token.

The term “structured financial attribute information” refers to data stored in the storage device in a predetermined schema or format, representing characteristics of a user's financial situation, including fields such as income, assets, liabilities, investment experience, surplus funds, and risk tolerance.

The term “income information” refers to financial attribute information indicating one or more income amounts of the user, such as annual salary, bonus, or other recurring revenue.

The term “asset information” refers to financial attribute information indicating one or more asset holdings of the user, such as cash, deposit balances, securities, or other property values.

The term “liability information” refers to financial attribute information indicating one or more obligations of the user, such as loans, credit card balances, or other debts.

The term “investment experience information” refers to financial attribute information indicating the user's past exposure to or familiarity with investment activities, such as a level of experience or categories of products previously used.

The term “surplus fund information” refers to financial attribute information indicating an amount of funds available for new allocation within a certain period, after accounting for expected income and expenditures.

The term “risk tolerance information” refers to financial attribute information indicating a degree to which the user is willing or able to accept variability in investment outcomes, such as low, medium, or high risk tolerance.

The term “constraint conditions” refers to predefined or dynamically determined parameters that restrict or guide the generation of answer information, including at least one of required answer format, target explanation depth, or mandatory risk description content.

The term “answer format” refers to a structural specification for the output of the generative information processing model, such as use of bullet points, numbered lists, sections, or length limits.

The term “level of explanation” refers to a specification of the desired complexity or detail of the generated answer, such as basic, intermediate, or advanced explanation.

The term “description of risk” refers to text in the generated answer that explains potential negative outcomes, variability, or uncertainty associated with financial options presented to the user.

The term “prompt sentence” refers to a text sequence generated by the processor that combines at least the extracted intention, financial-related elements, financial attribute information, and constraint conditions, and that is provided as input data to the generative information processing model.

The term “generative information processing model” refers to a machine learning model, such as a neural network model trained on large-scale data, configured to generate text-based output in response to a prompt sentence by performing numerical computation on internal parameters.

The term “answer information” refers to text-based content generated by the generative information processing model in response to the prompt sentence, including suggested financial actions, explanations, and risk descriptions.

The term “response data” refers to data received by the processor from the generative information processing model that contains the answer information suitable for further processing or presentation.

The term “cautionary text” refers to predetermined warning statements included in the output information to alert the user to potential risks, limitations, or conditions related to the generated content.

The term “disclaimer text” refers to predetermined statements included in the output information that clarify the legal or practical limitations of the generated content, such as indicating that the information does not constitute professional advice.

The term “output information” refers to data generated by the processor after post-processing the answer information, including added cautionary text or disclaimer text and formatting suitable for display on the terminal.

The term “communication network” refers to a wired or wireless data transfer infrastructure, such as the Internet, a mobile network, or a local area network, through which the server and the terminal exchange data.

The term “rule information” refers to stored data representing expert-derived conditions, guidelines, or decision rules that the processor uses to influence selection or adjustment of elements included in the prompt sentence or in the answer information.

The term “evaluation criterion information” refers to stored data representing expert-derived metrics or standards used to evaluate or compare financial options, such as criteria for risk level, liquidity, or cost.

The term “type of financial product” refers to a category of financial instrument or service, such as a deposit product, a debt instrument, an equity instrument, an investment fund, or an insurance product.

The term “viewpoint for comparison” refers to a criterion or axis along which multiple financial options are compared, such as risk level, expected return, liquidity, fees, or time horizon.

The term “saving ratio” refers to a quantitative financial indicator calculated from income and expenditure information, representing a proportion of the user's income that remains as savings.

The term “debt repayment burden” refers to a quantitative financial indicator representing a relationship between the user's debt repayment obligations and the user's income or cash flow.

The term “asset allocation status” refers to a quantitative or categorical representation of how the user's assets are distributed among different asset classes or financial products.

The term “investment risk level” refers to an indicator representing the degree of potential variability or loss associated with the user's overall investment portfolio or a proposed investment option.

The term “proposal information” refers to structured or semi-structured data generated by the processor that describes recommended actions or policies related to financial management based on calculated indicators and financial attribute information.

The term “household budget improvement policy” refers to a part of the proposal information that suggests changes to the user's income or expenditure patterns to improve financial stability or savings.

The term “expenditure reduction policy” refers to a part of the proposal information that suggests specific categories or methods for reducing spending.

The term “asset allocation policy” refers to a part of the proposal information that suggests how the user should distribute assets among different asset classes or products to achieve certain financial objectives.

The server implements embodiments of the invention as follows.

The server includes at least one processor, a main memory, a non-volatile storage device, a communication interface, and access to a data storage subsystem. The server operates under an operating system such as a general-purpose server operating system, and executes application software implementing natural language processing, database access, prompt sentence generation, and interaction with a generative AI model. The server may be implemented as a physical machine or as a virtual machine hosted in a cloud computing environment. The terminal includes a display, an input unit such as a touchscreen or keyboard, a communication module, and a local processor configured to execute a web browser or a native application. The user operates the terminal to interact with the server.

The server uses a set of software modules implemented, for example, in a high-level programming language such as Python. The server uses a natural language processing library such as NLTK or spaCy, a database access library such as a standard relational database driver, a web framework such as a conventional server-side web framework, and an HTTP client library to call an external generative AI model. The server stores structured financial attribute information in a relational database management system such as a common open-source or commercial relational database. The server stores rule information and evaluation criterion information representing expert knowledge in the same or a separate database using normalized tables.

The server uses the natural language processing software to convert input text from the user into structured representations. The server loads, for example, a spaCy pipeline including a tokenizer, part-of-speech tagger, dependency parser, and named entity recognizer. The server uses these components to detect tokens corresponding to financial concepts, temporal expressions, and monetary amounts. The server uses a classifier model, which may be implemented as a shallow neural network or as a gradient-boosted decision tree model, to map the extracted tokens and syntactic patterns to a discrete intention label, such as “short-term investment of surplus funds,” “comparison of payment methods,” or “savings optimization.” The server converts the intention label into a feature vector stored in memory.

The server uses the database access software to retrieve financial attribute information associated with the user. The server stores financial attribute information in tables including fields for income information, asset information, liability information, investment experience information, surplus fund information, and risk tolerance information. The server uses a user identifier, transmitted from the terminal as part of an authenticated request, to construct a parameterized query and to fetch one or more rows from the tables. The server maps each field to a normalized internal representation; for example, the server converts currency values to a common base unit and encodes risk tolerance as an integer or categorical value. The server stores the retrieved attributes in a structured data structure in memory, such as a dictionary managed by the application.

The server uses a prompt generation module to construct a prompt sentence for a generative AI model. The server combines three primary classes of data: (i) the structured representation of the user's intention and financial-related elements derived from the input text, (ii) the structured financial attribute information retrieved from the database, and (iii) constraint conditions retrieved from configuration data or rule tables. The server stores constraint conditions indicating target answer format (e.g., numbered list, bullet points), desired explanation depth (e.g., beginner-friendly, intermediate), and required risk description items (e.g., volatility, potential loss range, liquidity restrictions). The server also uses rule information and evaluation criterion information representing expert knowledge, stored in the database as parameter sets and decision tables. The server uses these rule sets to select which financial product categories and comparison viewpoints should be included in the prompt sentence.

For example, when the user has low risk tolerance, no investment experience, and a small surplus fund, the server uses rule information to increase weights for low-risk categories such as deposit products and short-term debt instruments, and to include explicit instructions in the prompt sentence to explain capital preservation and access to funds. The server implements this selection as a non-trivial algorithm that maps financial attribute vectors and intention labels into a set of “prompt directives,” each directive specifying a product type, risk-level explanation requirement, and comparison viewpoint. The server then serializes these directives into natural language segments that are appended to the prompt sentence.

An example of a prompt sentence generated by the server is as follows:

“User's financial profile:
Annual income: 5,000,000 JPY
Savings: 1,000,000 JPY
Liabilities: housing loan with monthly payments of 90,000 JPY
Investment experience: none
Risk tolerance: low
Surplus funds this month: 100,000 JPY

User's question:

‘How should I invest my surplus funds this month?’

Requirements:
Propose 2-3 concrete options suitable for a beginner with low risk tolerance.
Consider safe or relatively low-risk products such as deposit products, government bonds, or broadly diversified funds.
For each option, explain: (1) the risk level (low/medium/high), (2) the typical investment period and liquidity, and (3) main advantages and disadvantages.
Use clear, non-technical language understandable to a non-expert.
Include a brief overall comparison of the options.
Add a short note that this is general information and not professional financial advice.”

The server prepares the prompt sentence as input to a generative AI model. The generative AI model may be implemented as a large-scale neural network, such as a transformer-based language model with multiple layers of self-attention and feedforward units. The server interacts with this model either through an external API or as an internally hosted model. In an external configuration, the server uses an HTTP-based API to send the prompt sentence, together with hyperparameters such as maximum token count and sampling temperature, to the generative AI model. In an internal configuration, the server directly loads the model weights into memory and executes forward passes on hardware accelerators such as graphics processing units or tensor processing units.

The generative AI model uses a learned embedding layer to convert tokens of the prompt sentence into high-dimensional vectors. The model processes these vectors through multiple attention layers, each computing attention scores over the sequence to capture long-range dependencies between elements such as the user's risk tolerance and the requested time horizon. The model outputs a probability distribution over the vocabulary for each position in the answer, and the server uses a decoding algorithm, such as greedy decoding or beam search with temperature control, to select a sequence of tokens representing the answer information. The server receives the generated text from the model as answer information.

In some embodiments, the generative AI model is trained in advance using large corpora of financial and general language text. The model is fine-tuned using domain-specific data that emphasize consumer financial advice. During training, the model minimizes a loss function such as cross-entropy between predicted token distributions and reference tokens. The optimization procedure updates model weights using gradient-based methods such as stochastic gradient descent or Adam. The training data include augmented examples in which structured financial profiles and corresponding advice are combined into prompt-target pairs, enabling the model to respond effectively to prompt sentences containing similar structure in deployment.

The server applies post-processing to the answer information. The server examines the answer text to verify that mandatory elements are present. The server may perform pattern-based checks using regular expressions or a secondary classifier to ensure that risk descriptions and disclaimers are included. When the answer text lacks required content, the server appends standard cautionary text or disclaimer text, and may add bridging phrases to maintain readability. The server then formats the answer into a consistent output structure, for example grouping content into labeled sections such as “Option 1,” “Option 2,” “Risk and Considerations,” and “Summary.” The server stores this structured output in a data structure that maps section labels to text segments.

The server uses a quantitative analysis module to compute additional financial indicators using both the financial attribute information and parameters extracted from the answer information. The server parses numeric values and terms in the answer text to identify, for example, suggested allocation percentages or recommended time horizons. The server computes a saving ratio by dividing a savings-related field by an income-related field stored in the database. The server computes a debt repayment burden by dividing total monthly debt payments by monthly income. The server constructs an asset allocation status vector that represents proportions of different asset categories in the user's current and proposed portfolios. The server derives an investment risk level by combining risk tolerance information from the database and risk-level descriptors from the answer information, using a scoring function defined in the rule information. The server uses these quantitative indicators to generate proposal information that describes recommended changes, such as revising the proportion allocated to low-risk products or adjusting monthly savings targets.

The server embeds the proposal information into the formatted output information. The server generates additional explanatory sentences that map numeric indicators to user-understandable messages, for example: “Your current debt repayment burden is approximately 30% of your monthly income, which is within a moderate range, but you should avoid increasing it further.” The server appends these messages to the answer sections or creates a separate “Financial Overview” section. The server generates output information that includes both the original answer content and the system-derived quantitative analysis.

The terminal receives the output information from the server and renders it on the display. The terminal may implement a native graphical user interface or a web-based interface. The terminal uses its local processor to parse the structured output information and to divide the answer into visually distinct elements, such as cards or expandable sections. The user reads the recommendations, scrolls through the view, and may provide feedback or follow-up queries. The terminal transmits any follow-up input back to the server in the same manner, allowing the server to reuse stored financial attribute information and context when generating subsequent prompt sentences.

This configuration improves computer technology rather than merely automating human advisory tasks. The server realizes a specific data flow and algorithmic architecture in which unstructured natural language input is converted into structured representations, combined with normalized financial attributes, transformed into constrained prompt sentences, and processed by a neural network model with a specific architecture. Because the server uses rule information and evaluation criterion information to construct prompt sentences, the server reduces the need for iterative clarification and redundant round trips. This reduces overall communication load between the server and the generative AI model and between the server and the terminal. The prompt sentence includes explicit and machine-checked constraints, allowing the generative AI model to produce answer information that already conforms to required formats and risk descriptions, which reduces post-processing overhead.

The server achieves improved accuracy and consistency by enforcing a non-conventional prompt generation pattern that encodes expert-derived rules into the text provided to the generative AI model. The causal relationship is that the structured, rule-informed prompt sentence allows the neural network to concentrate its computation on generating content specific to the user's financial attributes and risk profile, rather than inferring missing context. This improves alignment between the model's internal representations and the structured data, leading to lower error rates in recommended risk levels and more stable outputs across similar user profiles.

The server improves processing efficiency by caching intermediate representations. For example, the server may store derived intention labels and financial attribute vectors for a session, and reuse them across follow-up questions, only recomputing the minimal differences in prompt sentences. This reduces repeated execution of natural language processing routines and database queries, decreasing CPU utilization and database load. The server may also implement token-length optimization methods that truncate or summarize portions of financial attribute information when they are redundant given the user's stated intention, thereby reducing the token count of the prompt sentence and lowering computation time in the generative AI model.

The server employs a data structure design that facilitates efficient technical operations. Financial attributes are stored as rows in normalized tables with indexes on user identifiers and frequently queried fields. Intentions and extracted entities are represented as compact codes linked to natural language terms by mapping tables. Prompt directives are stored as structured objects, separating semantic parameters from their linguistic realizations. This separation allows the server to optimize the generation of prompt sentences by using pre-composed templates and variable substitution, minimizing string manipulation overhead. The combination of these design decisions results in reduced latency from user query to answer display and more predictable resource consumption on the server.

In some embodiments, the server runs the generative AI model locally. In such an embodiment, the server loads model weights from the storage device into a memory associated with a hardware accelerator. The server processes batched prompt sentences using the accelerator's matrix multiplication engines, reducing per-request latency by exploiting parallelism. The server quantizes certain layers of the model to lower precision, such as 8-bit integer representations, for inference, thereby reducing memory bandwidth requirements and increasing throughput. The server uses a scheduler to allocate accelerator time among multiple user sessions, prioritizing requests based on predefined criteria. These operations directly impact physical hardware resource control and improve device utilization.

In alternative embodiments, the server may use different neural network architectures, such as recurrent neural networks or hybrid architectures that combine recurrent and attention-based layers, as long as they perform generative text computation in response to the prompt sentence. The server may employ different training strategies, such as curriculum learning, where training data are organized from simple to complex financial scenarios, or data augmentation, where synthetic financial profiles and advice pairs are generated to increase robustness. The server may use different loss functions, such as label-smoothed cross-entropy, and may apply regularization methods such as dropout or weight decay to improve generalization. These choices affect the internal behavior of the model and the statistical properties of its outputs, but the overall system behavior remains consistent with the claims.

The server may also incorporate additional modules for safety and policy compliance, such as a secondary classifier that inspects answer information for prohibited content. The server can implement this classifier as a separate neural network trained on labeled examples of acceptable and unacceptable responses. When the classifier detects a violation, the server may regenerate the answer using a modified prompt sentence that includes stronger constraints or may mask certain segments of the output. This additional layer of automated control further improves reliability and reduces the need for manual review.

Through these embodiments, the server, the terminal, and the user operate together in a system where the server's internal program structure, data structures, and hardware utilization patterns are specifically engineered to process natural language financial queries, integrate structured financial data, generate constraint-aware prompt sentences for a generative AI model, and transform the resulting answer information into structured, quantitatively informed advice. The described configurations and variations demonstrate that the invention can be implemented in multiple ways, and that a person skilled in the art can realize the claimed system using the disclosed hardware and software arrangements.

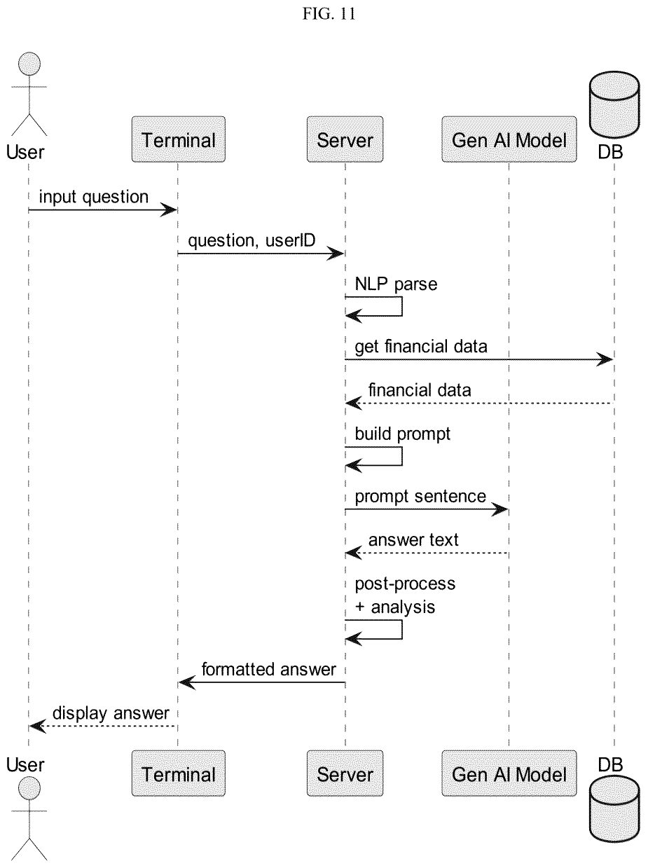

The following describes the processing flow using FIG. 11.

### Step 1

The user operates the terminal to open a finance advisory screen and to input a natural language question.

The input is raw text typed or spoken by the user, such as “How should I invest my surplus funds this month?”.

The terminal converts the user's operation into a character string, associates it with user identification data (for example, a user ID or session token), and packages these as a request message.

The terminal sends the request message to the server over a communication network using a protocol such as HTTPS.

The output of this step is a network request containing the user's natural language question and identification data.

### Step 2

The server receives the request message from the terminal through a communication interface.

The input is the network request containing the user's natural language question and identification data.

The server parses the request headers and body, decodes the character encoding of the text, and verifies that the user identification data correspond to an authenticated session by comparing with authentication records in a storage device.

The server discards malformed or unauthorized requests and, for valid requests, stores the raw question text and identification data in working memory for further processing.

The output of this step is a validated question text string and an associated user identifier stored in server memory.

### Step 3

The server performs natural language preprocessing on the question text using a natural language processing function.

The input is the validated question text string.

The server uses a tokenizer (for example, provided by an NLP library such as NLTK or spaCy) to split the text into tokens, a part-of-speech tagger to label grammatical roles, and a dependency parser to identify relations between tokens.

The server applies an entity recognizer to detect financial entities, such as monetary amounts, time expressions, and financial product names.

The server then feeds derived features (such as token n-grams, part-of-speech patterns, and entity labels) into a classification model that maps the text to an intention label (for example, “short-term investment of surplus funds” or “comparison of cash vs. loan purchase”).

The output of this step is a structured representation including an intention label and a set of financial-related elements (such as time horizon, risk preference clues, and target asset type indicators).

### Step 4

The server retrieves structured financial attribute information from a storage device based on the user identifier.

The input is the user identifier obtained in Step 2.

The server generates one or more parameterized database queries to a relational database that stores user financial profiles, selecting fields such as income information, asset information, liability information, investment experience information, surplus fund information, and risk tolerance information.

The server executes the queries via a database driver and fetches the matching rows. The server normalizes numerical values (for example, converts different currencies to a common base, aggregates multiple asset entries) and encodes categorical values (for example, maps “beginner” to a predefined experience level code).

The output of this step is a normalized financial attribute object containing key attributes of the user's financial situation.

### Step 5

The server determines constraint conditions and expert-derived parameters for prompt sentence generation.

The input is the intention label and financial-related elements from Step 3 and the financial attribute object from Step 4.

The server accesses rule information and evaluation criterion information stored in the storage device, using the intention label and risk tolerance indicators as keys to select applicable rules.

The server computes a set of “prompt directives,” each directive specifying at least a financial product category to be mentioned, a level of explanation to be provided, and a risk description schema to be applied. For example, the server chooses low-risk product types and simple explanation level when the risk tolerance is low and investment experience is minimal.

The output of this step is a structured directive set that indicates what content and constraints the subsequent prompt sentence must contain.

### Step 6

The server generates a prompt sentence for input to the generative AI model.

The input is the structured directive set from Step 5, the intention and financial-related elements from Step 3, and the normalized financial attribute object from Step 4.

The server assembles these pieces into a coherent text block by inserting financial attribute values, intention descriptions, and explicit requirements into template strings.

The server ensures that the prompt sentence includes: (i) a description of the user's financial profile, (ii) a verbatim or paraphrased version of the user's question, and (iii) explicit instructions for the desired number of options, risk explanations, format, and disclaimer requirements.

The output of this step is a complete prompt sentence expressed as a natural language string ready to be transmitted to the generative AI model.

### Step 7

The server transmits the prompt sentence to a generative AI model and obtains answer information.

The input is the prompt sentence string generated in Step 6.

The server sends the prompt sentence to an internal or external generative AI model using an appropriate interface, such as an HTTP-based API or a local model invocation.

Inside the generative AI model, the prompt sentence is tokenized, mapped through an embedding layer into numerical vectors, and processed by a multilayer neural network (for example, a transformer architecture with multiple self-attention and feedforward layers) that performs matrix multiplications and nonlinear transformations on the vectors.

The generative AI model calculates probability distributions over a vocabulary for each output position and decodes a sequence of tokens representing answer information, using a decoding algorithm such as greedy decoding or beam search with sampling temperature parameters.

The server receives the generated token sequence, converts it back into a text string, and stores this text as answer information in memory.

The output of this step is a text-based answer information string that reflects the content requested in the prompt sentence.

### Step 8

The server performs post-processing and formatting on the answer information.

The input is the answer information string obtained in Step 7.

The server analyzes the text using pattern matching or a lightweight classifier to check for the presence of required sections, such as risk descriptions and high-level summaries.

The server appends standard cautionary text or disclaimer text when required content is missing or incomplete and may insert transition phrases to maintain fluency.

The server segments the answer text into labeled sections (for example, “Option 1,” “Option 2,” “Risks,” “Summary”) by detecting markers such as numbered lists or headings, and, if absent, the server inserts such markers based on its own structural rules.

The output of this step is structured output information, including formatted sections and appended warning or disclaimer statements, ready for presentation.

### Step 9

The server performs quantitative analysis based on the financial attribute information and the formatted answer information.

The input is the normalized financial attribute object from Step 4 and the formatted answer information from Step 8.

The server computes indicators such as saving ratio by dividing savings-related values by income-related values, and debt repayment burden by dividing total periodic debt payments by periodic income.

The server constructs an asset allocation status vector by classifying existing assets and any recommended allocations from the answer information into predefined asset categories and calculating proportion values.

The server calculates an investment risk level by combining user risk tolerance data with risk level descriptors extracted from the answer text, applying a scoring function that maps qualitative labels (such as “low” or “medium”) and quantitative thresholds to a numerical or categorical risk score.

The server generates proposal information that translates these computed indicators into concrete recommendations, such as adjustments to savings targets, suggested limits on additional borrowing, or target proportions for different asset classes.

The output of this step is enriched output information that includes both the original formatted answer content and additional quantitative proposal information.

### Step 10

The server transmits the enriched output information to the terminal for display.

The input is the enriched output information generated in Step 9.

The server encapsulates the output information into a response message, sets appropriate response headers, and sends the message over the communication network to the terminal.

The terminal receives the response, decodes the data, and maps the structured sections and indicators into visual components such as headings, paragraphs, charts, or highlighted warnings.

The terminal renders the information on the display so that the user can review recommended options, risk explanations, and quantitative indicators.

The output of this step is a rendered user interface on the terminal, showing the processed answer and proposal information to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented financial advisory systems typically rely on fixed rule sets or static templates to generate recommendations. In such systems, a processor often retrieves user financial data, applies predetermined thresholds or heuristics, and outputs generic advice, without dynamically tailoring the advisory content to the user's detailed cash-flow structure, goal-achievement feasibility, or preferred presentation format. As a result, the generated output is frequently either too coarse to support concrete decision-making or too complex and unstructured to be effectively consumed by users on resource-constrained client devices such as smartphones.

Furthermore, when a generative AI model is integrated into these systems, the processor commonly passes only high-level or incomplete user information as free-form text. The prompt construction is ad hoc and does not systematically incorporate structured financial aggregates, such as period-based inflows and outflows, surplus funds, goal gaps, or expenditure category breakdowns. This limits the ability of the generative AI model to perform accurate reasoning over the user's financial situation and leads to responses that are verbose, inconsistent, or misaligned with the user's actual constraints.

Additionally, known systems do not adequately address the technical problem of converting the unstructured natural-language output of a generative AI model into machine-usable structured data that can be efficiently rendered, filtered, and updated on the client side. In many cases, the client device is forced to perform heavy parsing and reformatting or to display long text blocks, which degrades responsiveness, consumes excess bandwidth, and impairs the user experience. From a computer-technology standpoint, this results in inefficient use of processing resources in the server and the client, redundant data transfers, and poor scalability when many users request real-time advisory results.

There is also a lack of mechanisms by which a processor can automatically evaluate and control the quality of the generative AI output in light of domain-specific guidelines. Without a server-side inspection and correction pipeline driven by expert-derived rules, the system may repeatedly produce responses that are unsuitable, inconsistent, or non-compliant with financial advisory constraints, requiring manual intervention and reducing system reliability.

Accordingly, there is a need for an improved computer-implemented financial advisory system in which a processor (i) performs systematic aggregation and transformation of raw financial data into higher-level metrics and categories, (ii) generates prompt sentences that encode these metrics and simulation conditions in a structured manner for a generative AI model, (iii) post-processes the AI model's unstructured response into structured data optimized for presentation and reuse, and (iv) optionally enforces expert-derived evaluation rules. Such a system should improve computational efficiency, data-flow efficiency, and the technical quality and usability of the generated advisory content, thereby achieving an improvement in computer technology itself rather than merely automating a human advisory workflow.

The specific processing by the specific processing unit 290 of the data processing device 12 in Application Example 1 is realized by the following means.

The present invention provides a server comprising a processor and a storage unit, wherein the processor is configured to store, in the storage unit, financial information and target information acquired from a user via an operation terminal, to perform data processing that aggregates inflow and outflow information included in the financial information by period and by category so as to calculate surplus funds and a saving amount required to achieve a target, to generate a prompt sentence for input to a generative AI model by embedding, into natural language text, the surplus funds, a target saving amount, a target period, user attribute information, and expenditure category information obtained by the data processing, to input the prompt sentence into the generative AI model and obtain response information including an investment plan and expenditure reduction proposals based on a text generation process executed by the generative AI model, and to analyze the response information to extract asset allocation information, risk level information, and expenditure reduction item information and convert the extracted information into structured data that is output in a format presentable to the operation terminal. This enables the server to transform low-level transactional and goal data into higher-level financial indicators, to encode those indicators into a machine-generated prompt sentence that drives targeted reasoning by the generative AI model, and to convert the resulting unstructured natural-language output into structured advisory data that can be efficiently transmitted, rendered, and iteratively updated on client devices, thereby improving the technical operation of the computer system in terms of data processing efficiency, response quality control, and usability of AI-generated financial recommendations.

The term “financial information” refers to data indicating a user's financial status, including at least transaction records, inflow and outflow amounts, balances, income, expenses, and other monetary values associated with one or more financial accounts.

The term “target information” refers to data indicating a user's financial objectives, including at least a target saving amount, a target period for achieving the target saving amount, and optionally constraints or preferences related to investment or saving behavior.

The term “operation terminal” refers to an information processing device operated by a user, including at least a portable terminal, a stationary terminal, or a communication-capable display device, that is configured to transmit user inputs and receive output data from a server.

The term “storage unit” refers to a hardware or virtualized storage resource, including at least a memory device or a non-volatile storage device, that is configured to store financial information, target information, and intermediate or final processing results.

The term “inflow and outflow information” refers to data representing monetary inflows and monetary outflows associated with financial accounts, including at least deposits, withdrawals, payments, transfers, and charges recorded in transaction histories.

The term “period” refers to a time interval used for aggregating financial information, including at least a day, a week, a month, a quarter, or a year.

The term “category” refers to a classification label assigned to a transaction or expenditure, including at least categories such as housing, food, utilities, transportation, subscriptions, entertainment, and other expense or income types.

The term “surplus funds” refers to a calculated monetary amount representing a difference between aggregated inflows and aggregated outflows for a given period, indicating an amount that remains available after expenses.

The term “saving amount required to achieve a target” refers to a calculated monetary value representing an amount that needs to be saved over one or more periods to reach a target saving amount within a specified target period.

The term “user attribute information” refers to data describing characteristics of a user, including at least age, location, investment experience, risk tolerance, and other attributes relevant to financial planning.

The term “expenditure category information” refers to data indicating one or more categories to which expenditures belong, and optionally including aggregate values, frequencies, and trends associated with those categories.

The term “prompt sentence” refers to natural language text that is constructed to be provided as input to a generative AI model, and that encodes financial indicators, constraints, simulation conditions, and instructions for generating a response.

The term “generative AI model” refers to a machine learning model configured to generate text or other content based on an input prompt, and implemented using at least a neural network architecture capable of performing inference to produce natural-language responses.

The term “response information” refers to data output by the generative AI model in response to a prompt sentence, including at least natural-language text describing an investment plan, expenditure reduction proposals, or other financial advice.

The term “investment plan” refers to information indicating a recommended strategy for allocating financial resources, including at least suggested asset classes, allocation ratios, time horizons, and associated risk levels.

The term “expenditure reduction proposals” refers to information indicating one or more suggested actions for reducing expenditures, including at least specific categories or items to reduce and an explanation of potential financial impact.

The term “asset allocation information” refers to data indicating a distribution of financial resources among different asset types, including at least percentages or amounts assigned to cash, deposits, securities, funds, or other investment instruments.

The term “risk level information” refers to data indicating a degree of expected variability or uncertainty associated with an investment plan, including at least qualitative or quantitative indicators of low, medium, or high risk.

The term “expenditure reduction item information” refers to data indicating particular expenditure items or categories that are identified as candidates for reduction, and optionally including reduction amounts or reduction rates.

The term “structured data” refers to data organized according to a predefined schema, including at least key-value pairs, tables, or hierarchical records, that allow a client device to programmatically access and present advisory content.

The term “evaluation rules” refers to machine-readable conditions, constraints, or scoring criteria defined on the basis of expert knowledge, and used by a processor to automatically inspect and judge the suitability or compliance of response information.

The term “guidelines” refers to rule sets or policies derived from domain expertise, including at least recommended practices, prohibitions, and boundary conditions, which are applied to control or adjust the content of response information.

The term “simulation conditions for expenditure reduction” refers to parameters used to model hypothetical scenarios of reduced expenditures, including at least reduction rates, affected categories, and simulation periods.

The term “proposals related to financial management” refers to response information generated under simulation conditions, including at least suggestions for budgeting, saving, investing, or reallocating resources to improve a user's financial situation.

In one embodiment, a server, a terminal, and a user cooperate to implement the invention.

The server includes at least one processor, a storage unit, a communication interface, and a memory storing instructions that, when executed by the processor, cause the server to perform the functions described below. The terminal includes at least one processor, a display, an input unit, a memory, and a communication interface, and is implemented, for example, as a smartphone, a tablet terminal, or a personal computer. The user operates the terminal to provide financial information and to receive advisory output.

The server uses general-purpose computing hardware such as a central processing unit and optionally an accelerator such as a graphics processing unit. The server executes application logic implemented, for example, in a high-level programming language such as a scripting language and uses a web framework, a data analysis library, a machine learning framework, and a relational database management system. The terminal executes an application implemented in a native mobile language or a cross-platform framework and communicates with the server over a secure communication protocol.

The server stores financial information and target information received from the terminal in the storage unit. The financial information includes at least transaction records, inflow and outflow amounts, and balances associated with one or more user accounts. The target information includes at least a target saving amount and a target period. The server organizes this information in tables such as a user table, an account table, a transaction table, and a goal table. Each table is indexed by a user identifier to enable efficient retrieval and update operations.

The server performs data processing on the transaction table to derive higher-level indicators. The server uses data structures such as columnar data frames in a data analysis library to represent each transaction as a row having fields including date, amount, type (inflow or outflow), and category. The server converts date strings into time objects, normalizes currency formats, and removes duplicate entries by checking combinations of fields. The server classifies uncategorized transactions by applying a classification model or a rule-based mapping using a feature vector consisting of tokenized description terms, amount ranges, and counterpart information. The classification model can be implemented using a machine learning library such as a gradient boosting classifier or a simple neural network, trained on historical labeled data.

The server aggregates the inflow and outflow information by period and by category. The server groups the transactions by a discrete time interval such as month and by a category label such as housing, food, utilities, and subscriptions. For each period and each category, the server calculates sums, averages, and counts. The server derives, for each period, a total inflow and a total outflow, and computes surplus funds as a difference between the total inflow and the total outflow. The server further calculates an average surplus over a plurality of periods to reduce the sensitivity to temporary fluctuations. The server uses vectorized operations provided by the data analysis library to perform these computations, which reduces the number of iterations and improves computation speed compared to naïve loop-based processing.

The server calculates a saving amount required to achieve a target by combining the aggregate financial information and the target information. The server obtains a current asset value by summing the balances of the relevant accounts. The server calculates a remaining period until the target date. The server computes a required saving per period using a formula based on the difference between the target saving amount and the current asset value divided by the remaining periods. Optionally, the server uses an interest or expected return factor to model the effect of investment returns on the required saving, by solving a recurrence relation for future value under periodic contributions.

The server generates a prompt sentence for a generative AI model by embedding, into natural language text, the surplus funds, the target saving amount, the target period, user attribute information, and expenditure category information. The server constructs the prompt sentence using a template and fills in placeholders with computed values and classified categories. The prompt sentence is constructed so that it explicitly encodes structured indicators as natural-language bullet points or labeled fields, thereby enabling the generative AI model to recognize and reason about precise numeric constraints and category breakdowns rather than vague narrative input.

For example, the server may generate the following prompt sentence:

“The user's financial profile is as follows:
Current total savings: 1,200,000 yen
Average monthly income: 300,000 yen
Average monthly expenses: 180,000 yen
Average monthly surplus funds: 120,000 yen
Target saving amount: 5,000,000 yen
Target period: 7 years from now
Investment experience: beginner
Risk tolerance: moderate
Major expenditure categories per month: housing 80,000 yen, food 50,000 yen, subscriptions 10,000 yen, entertainment 10,000 yen, others 30,000 yen

Task:
1. Propose at least two realistic investment plans that help the user reach or exceed the target saving amount within the target period.
2. For each plan, specify:
   Recommended asset classes and allocation ratios.
   Typical risk level and expected range of annual return.
3. Additionally, suggest specific ways to reduce spending in the above expenditure categories to increase the monthly surplus by at least 10,000 yen.
4. Use clear and concise language suitable for display on a smartphone screen.
5. Do not provide tax or legal advice.”

The server uses the communication interface to send the prompt sentence to the generative AI model. The generative AI model is implemented as a neural network having an encoder-decoder or decoder-only architecture with attention mechanisms. In one embodiment, the generative AI model is a transformer-based language model implemented using a machine learning framework. The model includes multiple layers of self-attention blocks, each block computing attention scores over token embeddings using learned weight matrices. The model stores parameters such as token embedding matrices, layer normalization parameters, attention projection matrices, and feed-forward network weights in a model storage.

The server tokenizes the prompt sentence using a tokenizer consistent with the generative AI model's vocabulary. The server converts the text into a sequence of token identifiers, then into token embeddings through a lookup in the embedding matrix. The model processes the embeddings through a sequence of attention and feed-forward layers. At each layer, the model computes query, key, and value vectors by multiplying the embeddings with learned weight matrices, calculates attention weights through scaled dot products and a softmax function, applies these weights to the value vectors, and passes the result through non-linear transformations. The model finally outputs a sequence of probability distributions over the vocabulary for each time step. The server samples or selects the most probable tokens according to generation parameters such as temperature and top-k or nucleus sampling thresholds, thereby generating a response text.

The server uses an error function, such as cross-entropy loss between predicted token distributions and reference tokens, during training of the generative AI model. The server updates the model weights using an optimization algorithm, such as stochastic gradient descent with momentum or an adaptive method, applied across mini-batches of training examples consisting of paired input prompt sentences and desired output responses. The server optionally applies regularization techniques such as dropout, weight decay, and data augmentation in the form of paraphrased prompts or synthetic financial scenarios to improve generalization. In a production environment, the server may further fine-tune the generative AI model on domain-specific datasets containing financial advisory dialogues, using additional loss terms that penalize outputs violating predefined domain constraints.

The server receives the response information generated by the generative AI model as a sequence of tokens, converts them back into text, and stores the raw response in the storage unit. The response information includes at least an investment plan and expenditure reduction proposals. The server analyzes the response information to extract asset allocation information, risk level information, and expenditure reduction item information. The server applies a parsing procedure that relies on pattern matching, keyword detection, and optionally a lightweight secondary model trained to recognize structured segments such as “Plan 1”, “Risk level”, and “Allocation”.

The server, for example, identifies numeric percentages followed by asset class names, such as “40% in global index funds” or “20% in bonds”, and maps them to key-value pairs in a structured data format. The server identifies phrases describing risk level, such as “low risk”, “medium risk”, or “high risk”, and associates them with the corresponding plan entries. The server detects expenditure categories mentioned in the response, such as “reduce subscription services by 2,000 yen per month” or “limit eating out to once per week”, and records them as expenditure reduction item information with categories, amounts, and suggested actions.

The server converts the extracted information into structured data, for example a hierarchical object representation that can be serialized as a structured message. The structured data includes arrays of investment plans, each having fields for plan name, asset allocation entries, risk level, and explanatory text, and arrays of expenditure reduction items, each having fields for category, reduction amount, and description. By generating this structured data on the server, the terminal is relieved from performing complex natural-language parsing, which reduces processing load on the terminal and decreases latency and energy consumption.

The server is further configured to inspect the response information obtained from the generative AI model in accordance with evaluation rules or guidelines defined based on expert knowledge. The server stores evaluation rules in a rules repository as machine-readable conditions, for example in the form of threshold checks, prohibited pattern lists, or scoring functions. The server checks whether recommended allocations exceed allowed maximums for certain asset classes, whether risk descriptions are consistent with expected volatility ranges, and whether expenditure reduction proposals avoid unrealistic or prohibited suggestions. If a violation is detected, the server may modify the prompt sentence to include additional constraints and request the generative AI model to regenerate the response, or the server may adjust the response directly by applying rule-based corrections. This evaluation and correction pipeline improves the consistency and reliability of the output and reduces the need for manual review.

In another embodiment, the server additionally calculates monthly aggregate values for each expenditure category and generates simulation conditions for expenditure reduction in the prompt sentence. For example, the server may compute that the average monthly subscription expense is 10,000 yen and prepares prompt text specifying a scenario such as “simulate a 30% reduction in subscription expenses and a 20% reduction in entertainment expenses.” An example of such a prompt sentence is:

“The user's current average monthly expenses by category are:
Housing: 80,000 yen
Food: 50,000 yen
Subscriptions: 10,000 yen
Entertainment: 10,000 yen
Others: 30,000 yen

Please propose specific changes to reduce subscription expenses by 3,000 yen per month and entertainment expenses by 2,000 yen per month, and explain how these reductions will affect the time required to reach the target saving amount of 5,000,000 yen within 7 years.”

By explicitly encoding simulation conditions as numeric constraints in the prompt sentence, the server enables the generative AI model to produce scenario-specific advice, which can be compared across different runs. The server can store multiple sets of structured recommendations corresponding to different simulation conditions and present them as alternative scenarios to the user.

The terminal displays the structured data received from the server. The terminal generates user interface components such as cards, lists, and charts to present the investment plans and expenditure reduction suggestions. The terminal does not need to process the raw natural-language response from the generative AI model, which reduces computation. The terminal can easily recompute visualizations such as pie charts of asset allocation and bar charts of category-wise expenditures using the structured data.

The described architecture yields technical effects beyond mere automation of human advisory tasks. Because the server aggregates raw transactional data into higher-level indicators using vectorized operations and structured data frames, computation is more efficient and scales to large numbers of users. Because the server constructs prompt sentences that encode structured financial metrics and simulation parameters, the generative AI model can converge to more accurate and relevant outputs with fewer tokens and fewer iterations, thus reducing processing time and communication bandwidth. Because the server converts the unstructured output of the generative AI model into structured data and enforces expert-derived evaluation rules, the system improves the reproducibility, quality, and machine-interpretability of AI-generated advice. These aspects collectively improve computer technology by optimizing data flow between modules, reducing resource consumption, and enabling reliable interaction between a complex neural model and conventional data-processing components.

In a variation of this embodiment, the server uses an alternative generative AI model architecture, such as a recurrent neural network with attention or a hybrid model, while still employing the same concept of encoding structured financial indicators into prompt sentences and decoding structured advisory content from the generated text. In another variation, the server executes the generative AI model locally on a dedicated inference server equipped with specialized acceleration hardware, while in yet another variation, the server accesses an external AI service through an application programming interface. In each case, the essential cooperation of the data aggregation, prompt sentence generation, AI inference, response parsing, and expert-rule evaluation modules remains similar.

In another embodiment, the terminal performs part of the pre-processing or post-processing. For example, the terminal may locally aggregate small volumes of transaction data into category totals before sending them to the server, which reduces the amount of raw transaction data transmitted. Alternatively, the terminal may perform additional local filtering or highlighting of structured advisory data to support user-specific preferences, without altering the fundamental server-side processes.

The system can further be adapted to different financial domains or regulatory environments by modifying the evaluation rules, the category definitions, and the prompt templates, without changing the underlying technical architecture. Thus, the invention provides a flexible and technically efficient framework for integrating generative AI models into financial advisory systems in a way that is tightly coupled to specific data structures, algorithms, and control flows, resulting in tangible improvements in processing speed, accuracy, and resource utilization.

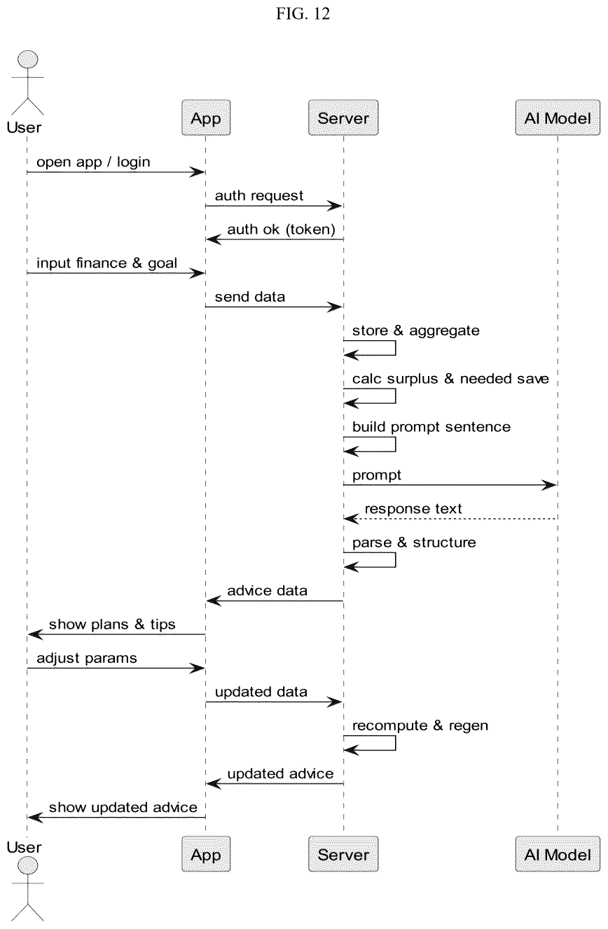

The following describes the processing flow using FIG. 12.

### Step 1

User operates the terminal to start a financial advisory application and authenticate.

User inputs login credentials (for example, identifier and password) into the terminal.

Terminal takes the credentials as input, constructs an authentication request, and sends the request to the server via a secure communication channel.

Server receives the authentication request as input, compares the credentials with records stored in a user table in a storage unit, and outputs an authentication result including a session token when verification succeeds.

Terminal receives the authentication result as input and stores the session token in a secure storage area as output for use in subsequent requests.

### Step 2

User operates the terminal to input financial information and target information.

User enters, into input fields on the terminal, at least account balances, income amounts, expense amounts, and a target saving amount with a target period.

Terminal takes the user-entered values as input, performs basic format validation (for example, numeric range checks and date format checks), and outputs a validated financial payload encoded in a structured format.

Terminal sends the validated financial payload together with the session token to the server as an input message.

### Step 3

Server receives the financial payload from the terminal as input and stores the contents in the storage unit.

Server parses the payload into internal data structures, assigns a user identifier based on the session token, and writes records into a user table, an account table, a transaction table, and a goal table.

Server performs data insertion and update operations using an access method such as an object-relational mapping interface and outputs a set of persistent records representing the user's current financial state and goals.

### Step 4

Server retrieves raw financial records from the storage unit as input for aggregation.

Server loads the transaction records into an in-memory tabular structure, converts date strings to time objects, normalizes currency fields, and removes duplicate entries by comparing composite keys.

Server applies categorization rules or a classification model to assign category labels to uncategorized transactions based on features such as description text and amount.

Server groups the cleaned transactions by period and by category, computes aggregate inflow and outflow amounts for each group, and outputs a period-category summary dataset that includes totals, averages, and counts.

### Step 5

Server uses the period-category summary dataset and goal records as input to calculate surplus funds and a saving amount required to achieve the target.

Server computes, for each period, a total inflow and a total outflow and calculates surplus funds as the difference between these totals.

Server averages the surplus funds across multiple periods to reduce the impact of fluctuations and retrieves a current asset value and a target saving amount from the account table and the goal table.

Server calculates the remaining number of periods until the target date, computes a required saving per period using the formula (target amount-current asset value) divided by remaining periods, and outputs numeric indicators including average surplus funds and required saving per period.

### Step 6

Server takes as input the numeric indicators, user attribute information, and expenditure category aggregates and constructs a prompt sentence for a generative AI model.

Server selects a template comprising natural-language instructions and labeled sections for financial metrics and simulation conditions.

Server fills placeholders in the template with computed values such as “Average monthly surplus funds: 120,000 yen” and with category-specific expenses such as “Subscriptions: 10,000 yen per month.”

Server assembles these text fragments into a coherent prompt sentence and outputs a finalized prompt sentence that encodes the financial indicators and task instructions.

### Step 7

Server sends the prompt sentence as input to the generative AI model through an application programming interface.

Server tokenizes the prompt sentence, maps tokens to numeric identifiers, and transmits the token sequence or the original text to an inference endpoint.

A generative AI model implemented as a neural network receives the prompt sentence, converts each token into an embedding vector, and processes the vectors through multiple layers of attention and feed-forward operations to compute probability distributions over output tokens.

Server receives the generated token sequence as output from the generative AI model and reconstructs it into response text, which constitutes raw response information including at least one investment plan and one or more expenditure reduction proposals.

### Step 8

Server analyzes the raw response text as input to extract structured advisory elements.

Server applies parsing rules and pattern-matching logic to detect segments such as plan titles, asset classes, allocation percentages, risk descriptors, and expenditure categories mentioned in reduction proposals.

Server converts detected phrases like “40% in global index funds, 20% in bonds, and 40% in cash” into structured fields, for example key-value pairs with numeric values, and maps risk descriptors such as “medium risk” to normalized risk levels.

Server similarly extracts expenditure reduction items, including target categories and reduction amounts, and outputs a structured advisory dataset containing arrays of investment plans and arrays of expenditure reduction items.

### Step 9

Server inspects the structured advisory dataset as input using evaluation rules and guidelines derived from expert knowledge.

Server checks whether allocation ratios sum to an allowable range, whether allocations exceed upper limits for given asset classes, and whether risk levels are compatible with the user's declared risk tolerance.

Server also checks whether expenditure reduction proposals reference valid categories and whether suggested reductions are within realistic bounds relative to historical spending.

When a violation is detected, server modifies the advisory dataset or adapts the prompt sentence to include additional constraints, optionally resubmits a refined prompt to the generative AI model, and outputs a corrected advisory dataset that conforms to the evaluation rules.

### Step 10

Server formats the corrected advisory dataset as structured data for delivery to the terminal.

Server organizes the dataset into a representation that includes identifiers for each investment plan, fields for asset allocation information and risk level information, and lists of expenditure reduction item information.

Server may also attach supplemental text derived from the raw response, along with metadata such as generation time and version indicators.

Server outputs a response message containing this structured data and transmits the message to the terminal via the communication interface.

### Step 11

Terminal receives the structured advisory dataset from the server as input and prepares it for presentation to the user.

Terminal parses the received structure, generates user interface components such as plan cards, allocation charts, and bullet lists of reduction proposals, and associates each component with relevant identifiers to support user interactions.

Terminal renders the components on the display as output, allowing the user to view key metrics, compare alternative plans, and inspect details such as specific allocation ratios and suggested cost reductions.

### Step 12

User views the displayed advisory content and may adjust parameters such as target saving amount, target period, or risk tolerance on the terminal.

Terminal captures the adjustments as new input, updates local representations of financial and target information, and transmits updated payloads to the server.

Server receives the updated payloads as input, re-executes aggregation, indicator calculation, prompt sentence generation, generative AI inference, response parsing, and evaluation, and outputs refreshed structured advisory data.

Terminal receives the refreshed data and updates the displayed plans and proposals, thereby supporting iterative refinement based on the user's preferences.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented financial advisory systems typically retrieve static financial information and apply fixed rule-based logic or simple statistical processing to generate recommendations. Such systems strain computer resources and provide suboptimal support for users' financial decision making for several reasons.

First, existing systems often treat the acquisition, preprocessing, pattern learning, and generation of natural-language advice as loosely coupled components, without an integrated control flow at the processor level. As a result, raw financial transaction data is repeatedly transformed and transferred between heterogeneous software modules, causing redundant computations, inefficient memory usage, and increased latency on the server. This leads to poor scalability when handling large volumes of time-series financial data for many users in parallel.

Second, many systems rely on generic prompts for generative AI models, which are manually crafted and not programmatically linked to structured, user-specific pattern information. Because the prompts are not dynamically constructed from normalized time-series features, predicted spending trends, and user goals, the generative AI model cannot fully exploit the available machine-readable data. This results in advice that is inconsistent, difficult to reproduce, and not easily optimized or evaluated in a systematic way. From a computer-technology perspective, the generative AI model is not being used as an efficient downstream component in a data-processing pipeline, but rather as a loosely attached text generator.

Third, known systems do not effectively use user feedback to adapt the end-to-end computational pipeline. Feedback is often stored only at a superficial level (for example, as a rating of the advice text) and is not used to update prompt-generation logic or learning conditions of the generative AI model in a structured manner. This prevents the system from improving the alignment between structured financial patterns and generated advice over time, and limits the ability of the processor to optimize resource usage by focusing computation on effective prompt patterns and model configurations.

Fourth, expert knowledge, when present, is frequently encoded in ad hoc business rules that are not systematically integrated into prompt-generation or model-control mechanisms. This makes it difficult for the processor to consistently reflect expert constraints or priorities in the generated proposals and to maintain such knowledge over updates to the model or the data schema. Consequently, there is a technical problem in representing expert supervision in a machine-usable form (such as rule information or weight information) that can be applied deterministically during prompt construction and model invocation.

Fifth, commonly used architectures do not provide machine-interpretable metrics, such as achievability indices and predicted reduction indices, as part of the same computational pipeline that generates natural-language advice. Even if such metrics are computed, they are typically post-processed in isolation and not used to control the content or priority of the proposals delivered to the user. This separation prevents the processor from performing consistent, metrics-driven selection and ordering of alternative proposals, resulting in inefficient use of computational resources and inconsistent user experiences.

Accordingly, there is a need for an improved computer-implemented system in which a processor centrally controls (i) secure acquisition and structured storage of time-series financial data, (ii) preprocessing and feature extraction optimized for generative AI learning, (iii) operation of a generative AI model to derive user-specific expenditure patterns and predictions, (iv) dynamic construction of prompt sentences embedding structured pattern data and user goals, (v) generation and storage of management information including category-wise targets, and (vi) feedback-driven updating of prompt-generation conditions and model-learning conditions. By integrating these functions into a coherent technical architecture, the processor can improve computational efficiency, reproducibility, and adaptability of generative financial advisory services, thereby providing a concrete improvement in computer technology itself rather than merely automating a human financial advisor's mental process.

The specific processing by the specific processing unit 290 of the data processing device 12 in Example 2 is realized by the following means.

The present invention provides a server comprising a processor and a storage device, the processor being configured to execute instructions to acquire authentication information from a user terminal, access a communication interface of an external information providing device using the authentication information, obtain time-series information including financial transaction information of a user via the communication interface, and store the obtained time-series information in the storage device; to perform preprocessing on the time-series information stored in the storage device using a general-purpose information processing program, the preprocessing including completion of missing values, removal of abnormal values, normalization of attribute information, aggregation for each time unit, and extraction of feature values for each expenditure category, and to generate training data that is learnable by a generative AI model; to operate the generative AI model constructed on a machine learning framework using the training data as input, to generate pattern information representing an expenditure tendency for each user and prediction information indicating a future expenditure amount, and to store the pattern information and the prediction information as structured data in the storage device; to generate a prompt sentence to be input to the generative AI model by dynamically generating the prompt sentence in accordance with a template based on structured data including the pattern information, the prediction information, and target information set by the user, and to embed the structured data in the prompt sentence so as to generate the prompt sentence for instructing generation of a saving proposal or a budget proposal related to financial management of the user; to call the generative AI model using the prompt sentence as input, obtain proposal information in natural language output from the generative AI model, and store the proposal information as management information including target value information for each expenditure category of the user in the storage device; to transmit the proposal information and the target value information stored in the storage device to the user terminal via a communication network and provide the proposal information and the target value information as notification information in a displayable format on the user terminal; and to acquire evaluation information or feedback information regarding the proposal information from the user terminal and update at least one of a generation condition of the prompt sentence and a learning condition of the generative AI model based on the evaluation information or the feedback information. This enables an integrated, processor-controlled data-processing pipeline in which time-series financial data is efficiently transformed into machine-learned expenditure patterns, dynamically structured prompt sentences, and metrics-based, user-specific financial proposals, thereby improving computational efficiency, adaptability, and technical performance of generative AI-based financial advisory systems.

The term “processor” refers to a hardware information processing unit, such as a central processing unit or a graphics processing unit, that executes computer-readable instructions to perform arithmetic operations, control operations, data transfer operations, and logic operations.

The term “storage device” refers to a hardware data storage component, such as a semiconductor memory, a magnetic storage medium, or an optical storage medium, that stores programs, parameters, intermediate data, and result data used or generated by the processor.

The term “user terminal” refers to an information processing apparatus, such as a portable communication device, a personal computer, or a tablet device, that is operated by a user and that communicates with the server via a communication network.

The term “authentication information” refers to information used by the processor to verify authorization for accessing an external information providing device, and includes, for example, credentials, tokens, or keys issued by an authentication mechanism of the external information providing device.

The term “external information providing device” refers to an information processing system or server controlled by an entity different from the server of the present invention, and that provides information such as financial transaction data via a communication interface.

The term “communication interface” refers to a hardware and software interface, such as an application programming interface or a network endpoint, that enables the server to send and receive data to and from the external information providing device via a communication network.

The term “time-series information” refers to data including multiple records each associated with a time value, such as date or time, and including at least financial transaction information of a user, ordered or orderable in chronological sequence.

The term “financial transaction information” refers to information representing one or more financial operations of a user, including at least a transaction date, a transaction amount, and optionally a transaction category, a merchant identifier, or a description of the transaction.

The term “general-purpose information processing program” refers to software executed by the processor that is not specific to a single user or a single model, and that performs common data-processing functions such as data cleaning, normalization, aggregation, and feature extraction.

The term “preprocessing” refers to a data-processing procedure applied to raw time-series information prior to model training or inference, including at least completion of missing values, removal of abnormal values, normalization of attribute information, aggregation for each time unit, and extraction of feature values.

The term “completion of missing values” refers to a process of filling or substituting absent or undefined data elements in the time-series information using predetermined rules, statistical methods, or estimation algorithms.

The term “removal of abnormal values” refers to a process of detecting data elements that deviate from expected ranges or patterns and eliminating or flagging such data elements from subsequent processing.

The term “normalization of attribute information” refers to a process of transforming values of one or more attributes, such as transaction amounts or counts, into a standardized numeric range or scale to facilitate numerical processing by a model.

The term “aggregation for each time unit” refers to a process of grouping multiple records in the time-series information according to a predetermined time unit, such as day, week, or month, and computing aggregated values such as sums, averages, or counts for each group.

The term “extraction of feature values for each expenditure category” refers to a process of deriving numerical or categorical values that represent characteristics of the time-series information for each spending category, such as food, transport, or entertainment, including aggregated amounts and statistical measures.

The term “training data” refers to data formatted as input-output pairs or input sequences suitable for use by a machine learning model, and generated by preprocessing the time-series information so that the model can learn patterns in the user's expenditures.

The term “generative AI model” refers to a machine learning model, such as a neural network-based language model or sequence model, that is configured to generate output data, including natural-language text, based on input data such as prompt sentences and structured pattern information.

The term “machine learning framework” refers to a software platform that provides functions for defining, training, and executing machine learning models, including numerical computation, automatic differentiation, and model serialization.

The term “pattern information” refers to structured data derived from the generative AI model that represents a user's expenditure tendency, including, for example, category-wise spending profiles or time-dependent spending behaviors.

The term “prediction information” refers to structured data derived from the generative AI model that indicates one or more future expenditure amounts or distributions across expenditure categories for a user.

The term “target information” refers to data that specifies one or more financial goals or constraints set by the user, such as a desired reduction rate in total expenses, a limit on category-wise spending, or a target savings amount.

The term “structured data” refers to data organized according to a predefined schema or format, such as key-value pairs, tabular records, or hierarchical objects, enabling deterministic processing and embedding into prompt sentences.

The term “prompt sentence” refers to a text string or sequence of tokens that is generated by the processor and provided as input to the generative AI model, the text string including instructions and data for controlling the behavior of the generative AI model.

The term “template” refers to a predefined linguistic or symbolic pattern used for constructing a prompt sentence, the template including placeholders into which structured data such as pattern information, prediction information, and target information is inserted.

The term “saving proposal” refers to advice information generated based on the generative AI model output that recommends actions or plans for reducing user expenditures or increasing savings.

The term “budget proposal” refers to advice information generated based on the generative AI model output that specifies target expenditure amounts or limits for one or more categories or time periods.

The term “proposal information” refers to natural-language text and optional structured elements output by the generative AI model in response to a prompt sentence, the text including at least one of a saving proposal and a budget proposal.

The term “management information” refers to data stored in the storage device that includes proposal information and associated target value information for each expenditure category of the user, used for management and display of financial recommendations.

The term “target value information” refers to numeric or symbolic values representing category-wise spending limits, goals, or thresholds derived from or associated with proposal information generated by the generative AI model.

The term “notification information” refers to data transmitted from the server to the user terminal that encapsulates proposal information, target value information, or summaries thereof in a format suitable for presentation on a display device.

The term “evaluation information” refers to data indicating a user's assessment of proposal information, including at least one of a rating, a selection of a preference, or a categorical evaluation.

The term “feedback information” refers to data input by the user that expresses reactions, constraints, comments, or additional preferences related to the proposal information, and is used to adjust future system behavior.

The term “generation condition of the prompt sentence” refers to parameters, rules, or templates that determine how the processor constructs the prompt sentence, including selection of content elements, ordering of information, and constraints on style or length.

The term “learning condition of the generative AI model” refers to training-related parameters or configurations for the generative AI model, including at least one of training data selection, learning rate, optimization procedure, or fine-tuning schedule.

The term “supervision information” refers to information derived from an evaluator having expert knowledge, including rules, priorities, or weight values, that is stored in the storage device and applied during generation of the prompt sentence or evaluation of model outputs.

The term “rule information” refers to machine-readable representations of expert-specified conditions or logical relationships, used by the processor to modify or constrain components of the prompt sentence or proposal information.

The term “weight information” refers to numerical or categorical parameters that represent the relative importance or influence of certain features, categories, or constraints when constructing prompt sentences or interpreting model outputs.

The term “output constraint conditions” refers to conditions imposed on the format, content, or length of the output of the generative AI model, such as limits on word count, required inclusion of certain categories, or prohibited types of statements.

The term “financial management proposal” refers to a set of one or more proposed strategies for managing a user's finances, including allocation of expenditures across categories and time, based on pattern information and prediction information.

The term “alternative” refers to an individual candidate plan or scenario within a financial management proposal that specifies a particular configuration of spending limits, adjustments, or behavioral changes.

The term “achievability index” refers to a metric computed for each alternative of the financial management proposal that indicates a degree of feasibility or likelihood that the user can implement the alternative, based on pattern information, prediction information, or user constraints.

The term “predicted reduction amount index” refers to a metric computed for each alternative of the financial management proposal that estimates a magnitude of reduction in expenditures or increase in savings expected if the alternative is implemented.

In one embodiment, a server cooperates with one or more terminals operated by a user to implement a financial management support system that utilizes a generative AI model controlled by structured prompt sentences. The server includes at least one processor and at least one storage device, and is connected to a communication network that allows communication with external information providing devices and the terminal.

The server executes an operating system such as a general-purpose server operating system on hardware that may include a multi-core central processing unit, a graphics processing unit suitable for numerical computation, a main memory, and a non-volatile storage device such as a solid-state drive. The server additionally executes middleware such as a web server, an application server, and a database management system, and executes application programs written, for example, in a high-level programming language. In a practical configuration, the server may use a relational database engine such as a general-purpose relational database management system and a machine learning framework such as a general-purpose tensor computation framework.

The terminal may be a smartphone, a tablet, or a personal computer, and may execute a native application or a web browser. The terminal includes at least a display, an input device, a network interface, and a processor that executes a client program for presenting user interfaces and communicating with the server. The user operates the terminal to provide authentication information, to set financial goals, and to view proposal information.

The server uses a communication interface such as a web application programming interface provided by an external information providing device to obtain time-series information including financial transaction information of the user. The server stores authentication information (for example, access tokens) in the storage device, associated with a user identifier. The server transmits requests to the external information providing device using a secure network protocol, and receives transaction records expressed in a structured format such as a list of objects. Each transaction record contains at least a transaction date, a transaction amount, and optionally a description and a preliminary category. The server parses these records and stores them in a transaction table of the relational database, where a primary key, a user identifier, a timestamp field, an amount field, and a category field are defined.

The server applies a general-purpose information processing program, written for example using a scientific computing library and a data frame library, to perform preprocessing on the transaction table. The server loads records for a given user into a data frame structure, where each row corresponds to a transaction and each column corresponds to an attribute such as date, amount, and category. The server performs completion of missing values by applying predetermined rules: for example, if a category is missing but a merchant description is present, the server applies a mapping table that maps merchant patterns to standardized expenditure categories. The server performs removal of abnormal values by computing statistical thresholds, such as an interquartile range or a percentile-based boundary, per user and per category, and then removing or flagging those records whose amounts lie outside the thresholds.

The server performs normalization of attribute information by applying scaling to numeric columns. The server, for example, computes a mean and a standard deviation for each numeric attribute (such as monthly spending per category) and transforms each value to a standardized score. The server aggregates transactions into fixed time units such as days, weeks, or months by grouping the data frame by user identifier and time unit, and summing or averaging the amounts for each category. This aggregation generates a sequence of vectors where each vector represents the user's spending per category for one time unit.

The server extracts feature values for each expenditure category by deriving additional features, such as moving averages over several previous time units, ratios of category amounts to total spending, and binary indicators of periodic events such as salary payment days. The server stores the resulting feature matrices, for example as multi-dimensional arrays or as additional tables with time unit keys, in the storage device. These feature matrices form training data that is formatted in a sequence form suitable for input to the generative AI model.

The server constructs the generative AI model using a machine learning framework such as a tensor-based library that supports automatic differentiation. In one embodiment, the generative AI model includes a neural network for learning expenditure patterns and a neural network for generating natural language. The expenditure-pattern network may be implemented as a recurrent neural network or a Transformer network. For example, the server may define a multi-layer recurrent structure with gated units that receive, at each time step, a feature vector representing the spending of one time unit. The network outputs a hidden state vector encoding expenditure tendencies over time, and optionally predicts the next time unit's category-wise amounts. The server defines a loss function such as mean squared error between predicted and actual category amounts and uses optimization algorithms such as stochastic gradient descent or Adam to update the network weights.

The server may alternatively or additionally define a Transformer-based encoder that converts sequences of time-unit feature vectors into a sequence of context-aware embeddings using self-attention layers. The server obtains an aggregate embedding (for example, by taking the embedding of a special classification token or by pooling over time) and treats this embedding as pattern information summarizing the user's expenditure behavior. The server trains this encoder using supervised objectives (for predicting future expenditures) and/or unsupervised objectives (for reconstructing or denoising input sequences), thereby learning a compressed representation suitable for downstream text generation.

The server stores the trained network parameters in the storage device as model parameters. For inference, the server loads the parameters into memory and performs forward passes on the feature sequences for each user. The server thereby computes pattern information, such as a latent vector representing the user's expenditure tendency, and prediction information, such as one or more predicted time-unit spending vectors for future periods. The server converts the prediction information back into actual currency amounts by inverting the normalization, and stores these values in a structured format, for example as a pattern table that includes the user identifier, time-unit identifiers, category identifiers, and predicted amounts.

The server then constructs a prompt sentence for a generative AI model that generates natural-language proposal information. The server in one embodiment combines an expenditure-pattern encoder and a language model in a pipeline. The server formats structured data including pattern information, prediction information, and target information set by the user into human-readable text embedded into the prompt sentence. For example, the server may construct a prompt sentence such as:

“You are a financial advisor. Analyze the following spending pattern and propose practical savings:

Average monthly spending (last 6 months): Food: 45,000 JPY, Transport: 10,000 JPY, Entertainment: 20,000 JPY, Utilities: 12,000 JPY.

Predicted next month: Food: 48,000 JPY, Transport: 10,500 JPY, Entertainment: 21,000 JPY, Utilities: 12,500 JPY.

The user wants to reduce total expenses by 10% next month.

Provide specific, actionable advice and a category-wise target budget. Keep the answer within 400 words.”

In another example, the server may construct a prompt sentence such as:

“The user's average Food spending is 45,000 JPY per month, and the predicted Food spending next month is 48,000 JPY.

The user's goal is to reduce Food expenses by 10% next month.

Generate a concrete weekly plan (including grocery planning and dining-out frequency) that helps achieve this goal. Keep the plan realistic for a full-time office worker.”

The server generates these prompt sentences dynamically using a template mechanism. The server stores one or more templates in the storage device, each template including textual segments and placeholders, such as “{CATEGORY}”, “{AVG_AMOUNT}”, “{PREDICTED_AMOUNT}”, and “{TARGET_REDUCTION}”. The server replaces these placeholders with values from the structured pattern information and target information. By embedding this machine-derived data into the prompt sentence, the server ensures that the generative AI model receives not only a natural-language description but also a precise numerical context, thereby improving the determinism and reproducibility of the generated proposals.

The server provides the constructed prompt sentence as input to a language-generating neural network configured as a generative AI model. The language model may be a Transformer-based autoregressive model with multiple self-attention layers and feed-forward layers. The server tokenizes the prompt sentence into tokens and passes the token sequence into the model. The model computes successive hidden state vectors and outputs probability distributions over the next token at each step. The server selects tokens based on a decoding strategy such as greedy decoding, beam search, or nucleus sampling, constrained by parameters such as temperature and maximum length. The server thus obtains a natural-language text that describes a saving proposal or a budget proposal.

The server stores the generated text as proposal information in the storage device, together with associated structured target value information, for example a category-wise target spending table derived either from the prediction information and the target reduction or directly from the model's output if the model outputs amounts explicitly. The server may post-process the proposal information using rule information and weight information representing supervision from an evaluator having expert knowledge. For example, the server may apply rules that require certain categories to be mentioned or prohibit unrealistic suggestions. The server may also adjust weights for different categories so that the proposals emphasize categories where reductions are more feasible. This rule-based post-processing allows the server to combine learned patterns with deterministic constraints in a way that is not typical of human manual advice.

The server transmits the proposal information and target value information to the terminal using a communication protocol such as HTTP over a secure transport. The terminal receives the data and displays it on a screen. The terminal may present the natural-language proposal as a text block and may additionally render graphical elements, such as charts comparing current average spending with target spending. The user views the proposal and may input evaluation information, such as selecting that the proposal is helpful or not helpful, and may provide feedback information, such as comments describing constraints or preferences.

The server receives the evaluation information and feedback information from the terminal. The server stores the feedback in a feedback table, which includes fields such as user identifier, proposal identifier, rating, and comment text. The server uses this information to update the generation conditions of the prompt sentence and the learning conditions of the generative AI model. For example, the server may adjust template selection rules to prefer templates that historically produced higher helpfulness ratings, or may adjust hyperparameters such as learning rate when fine-tuning the language model on high-rated proposals. The server may also use supervised fine-tuning, where portions of the generated text that received high ratings are used as target outputs for similar pattern inputs.

From a technical perspective, this configuration provides a concrete improvement to computer technology. The server reduces redundant data transfers and conversions by centralizing acquisition, preprocessing, pattern learning, prompt generation, and proposal generation in a coordinated pipeline on the same processor and storage device. The server improves computation efficiency by converting large volumes of raw transaction records into compact feature matrices and latent pattern vectors before text generation, thereby decreasing the amount of data that must be processed by the generative AI model. The server improves accuracy of generated proposals by systematically embedding machine-learned pattern information and user goals into prompt sentences using deterministic templates, rather than relying on manually written generic prompts.

The server improves data management by using structured tables for transactions, patterns, and feedback, enabling efficient indexing and retrieval of specific slices of time-series data and model outputs. The server further reduces communication load between the server and the terminal by transmitting only proposal information and target value information, rather than raw financial data or intermediate model states. The server achieves reduced computation time by reusing precomputed feature matrices and pattern information for consecutive proposal generations, rather than recomputing them for each query.

The server employs learning methods that are distinct from human mental processes, such as gradient-based optimization of high-dimensional weight matrices, automated extraction of non-linear patterns from raw sequences, and use of latent spaces to represent expenditure tendencies. The server applies non-conventional processing steps, such as combining encoder-generated pattern embeddings with template-based prompt construction and metric-based proposal selection, which are not ordinarily carried out by human advisors. Through the use of indices such as achievability indices and predicted reduction amount indices, computed numerically from pattern information and prediction information, the server can sort and prioritize alternative proposals in a way that scales computationally to large numbers of users and scenarios.

In variations, the server may adopt different neural network architectures within the same framework. For example, the server may use a variational autoencoder to model distributional characteristics of category-wise expenditures, and then derive pattern information as latent variables sampled from the encoder distribution. The server may also employ ensemble methods in which multiple generative AI models generate candidate proposals, and a ranking module, implemented as a separate neural network or a weighted rule engine, selects the proposal to send to the terminal. The server may further incorporate data augmentation techniques, such as adding noise to input feature vectors or simulating variations in spending patterns, to improve the robustness of the pattern-learning network.

In another embodiment, the server may execute the machine learning framework on a dedicated accelerator, such as a graphics processing unit or a tensor processing unit, while the database and web server run on general-purpose processors. The server coordinates data movement between these components so that only compact feature tensors and prompt tokens are transferred to and from the accelerator, thereby reducing bus traffic and latency. The server may also cache frequently used prompt templates and pattern summaries in a high-speed in-memory store to accelerate repeated proposal generation for frequently updated users.

In this way, the server, in cooperation with the terminal and the user, realizes a concrete, technically implemented system that transforms raw time-series financial data into structured pattern information, dynamically generated prompt sentences, and optimized proposal information through a specialized data-processing pipeline. The system thereby improves computational efficiency, response speed, and alignment of generated content with user-specific data, providing an advancement in computer-based generative AI technology beyond simple automation of human advisory tasks.

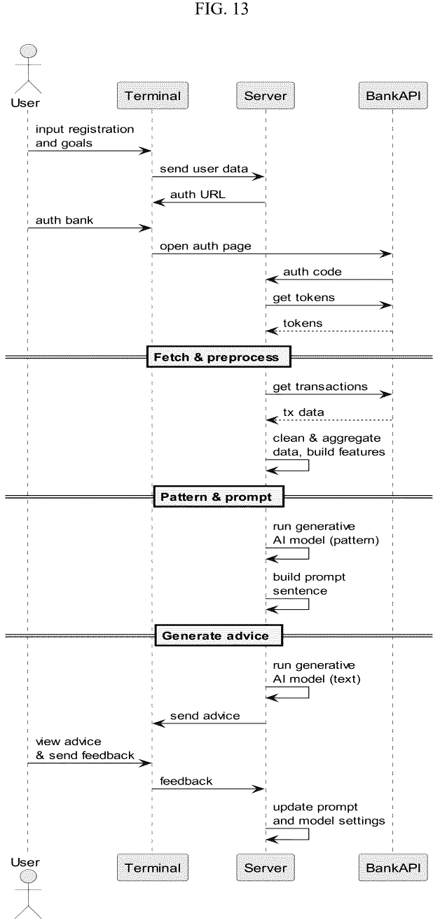

The following describes the processing flow using FIG. 13.

### Step 1

The user operates the terminal to input registration information and to select one or more external information providing devices.

The terminal sends, as input, user identification information and selection information for external information providing devices to the server.

The server generates, as output, account records in a storage device and an authorization request for obtaining authentication information. The server creates user entries in a user table and prepares redirect information or credential request data, which will be used to obtain access tokens from external information providing devices.

### Step 2

The user operates the terminal to complete an authentication process with the external information providing device.

The terminal receives, as input, an authorization URL or similar authentication instruction from the server and displays it to the user or opens a browser component.

The user provides login credentials and confirms access permission on an authentication screen of the external information providing device.

The terminal and the external information providing device generate, as output, an authorization code or equivalent credential, which is transmitted to the server. The server receives this authorization code and stores it temporarily in the storage device.

### Step 3

The server uses the authorization code as input to request authentication information from the external information providing device.

The server sends a token request via a communication interface, performing data operations such as constructing a protocol-compliant message, encrypting sensitive fields, and validating the response format.

The server receives, as output, authentication information including at least one access token and optionally a refresh token, and stores the authentication information in an authentication table in the storage device linked to the user identifier.

### Step 4

The server periodically uses the stored authentication information as input to access the communication interface of the external information providing device.

The server transmits data acquisition requests including time range parameters and access tokens, and receives, as output, raw time-series information including financial transaction information in a structured data format.

The server parses the received data, performs syntactic validation (such as type checking and required-field checking), and stores valid transaction records as rows in a transaction table, with each record including at least a user identifier, a timestamp, an amount, and an optional category label.

### Step 5

The server retrieves, as input, raw transaction records for a specific user and period from the transaction table in the storage device.

The server loads these records into an in-memory data structure, such as a data frame, and performs preprocessing operations to generate, as output, a cleaned and normalized transaction dataset.

The server executes data processing including completion of missing categories by applying a merchant-to-category mapping, removal or flagging of abnormal values using statistical thresholds (for example, filtering records with amounts beyond a user-specific percentile range), and normalization of numeric attributes by computing and applying scaling parameters. The server writes the cleaned dataset back to an intermediate table or file.

### Step 6

The server uses the cleaned dataset as input to perform aggregation for each time unit and to extract feature values for each expenditure category.

The server groups transaction records by user identifier, time unit (such as month), and category, and calculates aggregated values, such as total amount and average amount per category, producing, as output, an aggregated time-series table.

The server further computes derived feature values, such as moving averages over preceding time units, ratios of category amounts to total spending, and binary indicators for recurring events, and stores these feature vectors in a feature table or in matrix form in the storage device.

### Step 7

The server uses the feature vectors as input to a generative AI model constructed on a machine learning framework.

The server organizes the feature vectors into sequences of fixed length (for example, sequences of several time units) and feeds them into a neural network that includes layers such as recurrent layers or attention-based layers. The server performs data operations such as batch formation, tensor reshaping, and numerical computation of forward passes.

The server obtains, as output, pattern information representing the user's expenditure tendency (for example, a latent embedding vector) and prediction information indicating future expenditure amounts per category (for example, a predicted vector for the next time unit), and stores this information as structured records in a pattern table or as associated arrays in the storage device.

### Step 8

The server retrieves, as input, the pattern information, the prediction information, and target information specified by the user, such as a desired reduction rate or a spending limit.

The server applies a template mechanism to generate a prompt sentence by inserting numerical values and category names into predefined text templates. The server performs string-processing operations including placeholder replacement, numeric formatting, and conditional inclusion of sections, thereby generating, as output, a complete prompt sentence for the generative AI model.

For example, the server may generate the following prompt sentence as output:

“You are a financial advisor. Analyze the following spending pattern and propose practical savings:

Average monthly spending (last 6 months): Food: 45,000 JPY, Transport: 10,000 JPY, Entertainment: 20,000 JPY, Utilities: 12,000 JPY.

Predicted next month: Food: 48,000 JPY, Transport: 10,500 JPY, Entertainment: 21,000 JPY, Utilities: 12,500 JPY.

The user wants to reduce total expenses by 10% next month.

Provide specific, actionable advice and a category-wise target budget. Keep the answer within 400 words.”

### Step 9

The server uses the prompt sentence as input to a language-generating component of the generative AI model.

The server tokenizes the prompt sentence, converts tokens into embeddings, and passes these embeddings through multiple neural network layers configured in an autoregressive manner. The server performs data processing such as matrix multiplication, activation function evaluation, and attention weight computation to calculate probability distributions over candidate next tokens.

The server selects tokens sequentially according to a decoding strategy and generates, as output, natural-language proposal information, such as detailed saving advice and category-wise target budgets. The server stores the proposal information and any derived target value information in a management table in the storage device.

### Step 10

The server uses the stored proposal information and target value information as input for communication toward the terminal.

The server constructs a response message that includes the proposal text and structured target values, and transmits the message over a communication network. The server may also compress or encode the data to optimize bandwidth usage.

The terminal receives, as output, the response message, decodes it, and renders the proposal information on a display device as readable text and optionally as graphical elements such as charts or tables.

### Step 11

The user views, as input, the displayed proposal information on the terminal and evaluates its relevance and feasibility.

The user operates the terminal to input evaluation information, such as selecting a rating level, and may also input feedback information, such as textual comments indicating constraints (for example, “cannot reduce commuting cost”) or preferences (for example, “prefer to reduce dining-out rather than entertainment subscriptions”).

The terminal transmits, as output, the evaluation information and feedback information to the server in a structured format referencing the corresponding proposal identifier.

### Step 12

The server uses the evaluation information and feedback information as input to adjust internal control parameters.

The server updates records in a feedback table and performs data analysis, such as computing statistics of helpfulness scores per template or per category combination. The server uses these statistics to modify, as output, one or more generation conditions of the prompt sentence (for example, changing which template is preferred for certain spending patterns) and learning conditions of the generative AI model (for example, selecting data for fine-tuning or adjusting hyperparameters).

The server thereby refines future pattern-to-prompt mapping and model behavior based on quantitative feedback, enabling improved alignment between structured financial data, generated prompt sentences, and user-perceived usefulness of the resulting proposal information.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented financial advisory systems typically execute rule-based calculations or simple statistical analyses on stored financial data and then present generic recommendations to a user. In such systems, a processor often treats user transaction data, budget data, and user interactions as separate information streams, and merely aggregates static results. As a consequence, the underlying computer system suffers from several technical limitations.

First, the processor is not configured to perform integrated, multi-stage processing that transforms heterogeneous raw inputs (for example, noisy transaction logs, incomplete category labels, and unstructured inquiries) into a normalized, machine-learning-ready representation and then into dynamically updated prediction models. This lack of an end-to-end computational pipeline leads to inefficient use of memory and processing resources, repeated execution of redundant analyses, and increased latency when generating personalized financial outputs.

Second, known systems do not effectively combine time-series expenditure modeling with generative model prompting at the system level. In particular, conventional architectures do not automatically generate structured prompt sentences that encode learned expenditure tendencies, predicted future expenditures, budget and target saving constraints, and user reaction history in a single, machine-interpretable context. Instead, human operators or ad hoc scripts must manually craft input instructions to generative models, which results in non-repeatable behavior, inconsistent output quality, and increased processor load due to repeated trial-and-error calls to the generative model.

Third, existing systems generally ignore user emotion information as a first-class computational signal. Even when emotion is detected, it is often logged only for user-experience analytics and is not systematically fed back into the core computation path that drives model inputs, prompt structure, and selection of concrete actions. As a result, the processor cannot adapt its internal data flows and output generation mechanisms to changing user states, leading to suboptimal scheduling of computations, poor prioritization of notifications, and unnecessary processing of advice that the user is unlikely to follow.

Fourth, prior systems do not maintain a continuous learning loop that updates both expenditure tendency learning information and emotion tendency information based on user behavior history and feedback. Without this feedback-based update, the models and prompts become stale, so the processor continues to allocate resources to models and prompts that no longer match the user's current situation. This causes wasted computation cycles, increased network traffic for ineffective notifications, and degraded overall system responsiveness.

Accordingly, there is a need for a computer-implemented system in which a processor is technically configured to (i) normalize and organize transaction data in a structured manner suitable for machine learning, (ii) generate and update expenditure tendency learning information and expenditure prediction information, (iii) compute saving candidate information under budget and target saving constraints, (iv) derive emotion state information and emotion tendency information from heterogeneous user signals, (v) construct structured prompt sentences that encode these various types of information for a generative AI model, and (vi) update such learned information based on user response information and behavior history information. By improving these computational mechanisms, the computer system can reduce redundant processing, improve utilization of storage and processing resources, and generate more stable, efficient, and context-appropriate financial advice outputs with reduced latency and improved technical performance.

The specific processing by the specific processing unit 290 of the data processing device 12 in Application Example 2 is realized by the following means.

The present invention provides a server comprising a processor configured to perform natural language processing to analyze inquiry information received from a user, to access an information storage device to acquire financial trend information including transaction history information and balance information of the user, to normalize the acquired transaction history information on the basis of time-series information and classification information and store the normalized transaction history information as organized information, to input the organized information as training input information to a machine learning algorithm and generate expenditure tendency learning information, to generate expenditure prediction information for a future period on the basis of the expenditure tendency learning information, to compare the expenditure prediction information with budget information and target saving information and calculate reduction requirement information, to generate saving candidate information including saving candidate categories and saving effect amounts on the basis of the expenditure prediction information, the reduction requirement information, and the target saving information, to analyze emotion-related information acquired from the user and generate emotion state information and emotion tendency information, to generate structured information including at least the saving candidate information, the expenditure prediction information, the target saving information, and the emotion state information, to generate a prompt sentence for causing a generative AI model to generate a saving proposal response on the basis of the structured information, to input the prompt sentence to the generative AI model and acquire the saving proposal response, to extract concrete action plans and numerical effect information from the saving proposal response and generate notification information, to transmit the notification information to a user information terminal for presentation, and to acquire response information and behavior history information from the user and update at least one of the expenditure tendency learning information and the emotion tendency information on the basis of the response information and the behavior history information. This enables the server-side computer system to implement an integrated, iterative processing pipeline that transforms heterogeneous input data into machine-learning-ready representations, dynamically conditions generative AI model inputs through structured prompt sentences, and continuously refines internal models based on user behavior and emotion, thereby improving computational efficiency, resource utilization, response accuracy, and latency characteristics of the financial advisory processing performed by the processor.

The term “inquiry information” refers to information representing a request, question, or instruction input by a user in natural language or a structured format for the purpose of obtaining financial analysis or advice.

The term “natural language processing” refers to computerized processing that analyzes and interprets text or speech expressed in human language, including at least one of tokenization, part-of-speech tagging, parsing, intent detection, and keyword extraction.

The term “information storage device” refers to any hardware and software combination capable of storing digital data, including at least one of a local memory, a magnetic storage apparatus, a solid-state storage apparatus, or a remotely accessible database system.

The term “financial trend information” refers to digital data indicating temporal variations of a user's financial status, including at least transaction history information and balance information associated with one or more financial accounts.

The term “transaction history information” refers to digital records of financial transactions associated with a user, including at least each transaction's date, amount, counterparty or merchant, and, optionally, a transaction category or description.

The term “balance information” refers to digital data indicating a remaining amount of funds or credit associated with at least one financial account of a user at a given time.

The term “authentication information” refers to digital credentials used by a computer system to verify authority to access external resources, including at least one of an identifier, a password, a token, a certificate, or a cryptographic key.

The term “external institution” refers to a remote system that manages or provides access to financial data, including at least one of a financial service provider system, a payment service system, or an account aggregation system.

The term “normalize” refers to a computerized process of converting heterogeneous or inconsistent data into a standardized, consistent format, including at least alignment of date formats, category labels, numerical scales, and removal or correction of invalid values.

The term “time-series information” refers to data that associates individual records with temporal indicators, including at least timestamps, dates, or time intervals used to order or group financial events.

The term “classification information” refers to categorical labels or codes associated with financial records, including at least expenditure categories, income categories, or account types used for grouping or analysis.

The term “organized information” refers to normalized and structured data derived from raw financial data, stored in a form suitable for efficient querying, aggregation, and machine learning processing.

The term “machine learning algorithm” refers to a computerized procedure that processes training input information to derive parameters of a computational model capable of detecting patterns or making predictions from data.

The term “training input information” refers to digital data supplied to a machine learning algorithm for learning model parameters, including at least normalized and organized financial data for one or more users.

The term “expenditure tendency learning information” refers to model parameters or derived features generated by a machine learning algorithm that represent learned patterns of user expenditures over time and across categories.

The term “expenditure prediction information” refers to predicted values of future expenditures of a user, generated by applying trained model parameters to input data, and including at least predicted amounts per time period and category.

The term “budget information” refers to digital data indicating one or more target expenditure limits for a user, specified for at least one time period and at least one expenditure category.

The term “target saving information” refers to digital data indicating a user's desired saving objective, including at least an amount of savings and optionally a target period for achieving the savings.

The term “reduction requirement information” refers to digital data indicating one or more required reductions in predicted expenditures or categories in order to satisfy at least one of budget information or target saving information.

The term “saving candidate information” refers to digital data indicating one or more potential expenditure items or categories for reduction and associated saving effect amounts derived from predicted expenditures and reduction requirement information.

The term “saving candidate categories” refers to specific expenditure categories identified as targets for potential reduction, such as recurring discretionary spending categories.

The term “saving effect amounts” refers to numerical values indicating estimated reductions in expenditure or increases in savings resulting from applying a proposed change to one or more saving candidate categories.

The term “emotion-related information” refers to data obtained from user interactions that may indicate a user's emotional state, including at least one of text messages, voice signals, images, and behavior interaction logs.

The term “emotion state information” refers to data representing an estimated instantaneous emotional condition of a user, including at least one of anxiety, stress, calmness, confusion, satisfaction, or similar affective states.

The term “emotion tendency information” refers to data representing patterns or trends in a user's emotional states over time, including recurring variations associated with temporal or behavioral conditions.

The term “emotion analysis information” refers to a result of processing emotion-related information, including at least the emotion state information and emotion tendency information derived by an analysis procedure.

The term “structured information” refers to a composed data representation in which multiple types of information, including at least saving candidate information, expenditure prediction information, target saving information, and emotion state information, are organized in a format suitable for systematic processing by a generative AI model.

The term “prompt sentence” refers to a machine-readable and human-language-based instruction string that provides contextual information and commands to a generative AI model in order to control generation of a response.

The term “generative AI model” refers to a learned computational model that, given an input prompt sentence and optional structured data, generates output information such as natural language text, including at least one of a neural network-based language model or a sequence-to-sequence model.

The term “saving proposal response” refers to output information generated by a generative AI model in response to a prompt sentence, including at least textual content that proposes saving strategies, explanations, or action plans.

The term “concrete action plans” refers to specific operational instructions derived from a saving proposal response that the user can perform, including at least category-level reduction actions, scheduling changes, or spending limitations.

The term “numerical effect information” refers to quantified estimates of financial impact associated with one or more concrete action plans, including at least predicted changes in expenses, balances, or savings amounts.

The term “notification information” refers to output data formatted for delivery to a user terminal, including at least message content, associated action details, and optionally priority or timing information.

The term “user information terminal” refers to an electronic device operated by a user that presents information from the server and transmits user inputs, including at least one of a mobile communication device, a computing device, or a display apparatus.

The term “immediate notification information” refers to notification information configured to be presented promptly upon receipt, such as alerts or short messages indicating urgent or time-sensitive financial conditions.

The term “detailed explanation information” refers to notification information including extended descriptive or explanatory content that describes the rationale, background data, or steps associated with one or more concrete action plans.

The term “response information” refers to data indicating user reactions or inputs related to presented notification information, including at least acceptance, rejection, modification requests, or follow-up inquiries.

The term “behavior history information” refers to data representing one or more actions taken by the user over time, including at least spending changes, acceptance of proposals, or updates to financial settings, which can be associated with prior notifications or recommendations.

The term “learning update” refers to a computerized process of changing stored model parameters, derived information, or tendencies based on new data, such as response information and behavior history information, so as to refine future predictions or recommendations.

In one embodiment, a server cooperates with a terminal and a user to implement the claimed system. The server includes at least one processor, a main memory, a non-volatile storage device, and a network interface. The terminal includes at least one processor, a memory, a display device, an input device such as a touch panel or keyboard, and, optionally, a microphone and a camera. The server and the terminal communicate via a data network using a standard transport protocol.

The server executes software components including an operating system, a database management system, a natural language processing library, a numerical computation library, a machine learning framework, and a generative AI model inference engine. For example, the server executes a database engine to store and query transaction history information and emotion-related information, executes a numerical computation library such as a linear algebra library to perform aggregation and normalization, executes a machine learning framework such as a deep-learning framework to train and execute expenditure tendency learning models, and executes a language model runtime to process a generative AI model. The terminal executes an application or a browser to provide a user interface and to transmit and receive data to and from the server.

The server is configured to store financial trend information in a structured relational schema. The server defines, by way of example, a transaction table that contains fields for user identifier, account identifier, transaction date as a timestamp, transaction amount as a floating-point value, merchant identifier, and a normalized expenditure category as a categorical code. The server defines a balance table that contains fields for user identifier, account identifier, and current balance. The server defines a summary table that stores, for each user, each expenditure category, and each time period, an aggregated expenditure amount and statistical descriptors such as mean, variance, and maximum. The server defines further tables for saving candidate information, emotion state information, emotion tendency information, and user feedback.

The server executes a data normalization program that converts heterogeneous raw transaction history information into organized information. The server uses a mapping function to convert free-text merchant names into normalized expenditure categories. The server uses a date-parsing routine to convert various date and time formats into a canonical timestamp representation. The server uses a filter routine to remove duplicate records and to mark transactions that exhibit abnormal values, for example based on z-score thresholds relative to historical distributions. The server then stores the resulting organized information in the database in a columnar or row-wise structure optimized for analytical queries. By transforming irregular, text-heavy records into compact numeric and categorical representations, the server improves memory locality and cache utilization during later machine learning operations, thereby reducing processing time and improving throughput.

The server is configured to generate expenditure tendency learning information by means of a supervised time-series learning algorithm. The server selects, for each user, a sliding window of past time periods, and constructs feature vectors representing aggregated expenditures per category, temporal features such as day-of-week indicators and month indicators, and, optionally, simple macroeconomic features. The server normalizes each continuous feature dimension using stored scaling parameters, such as mean and standard deviation, so that input values are centered and scaled. The server then feeds these sequences of feature vectors into a neural network implemented in the machine learning framework.

In one embodiment, the server uses a recurrent neural network architecture, such as a long short-term memory (LSTM) network with multiple layers. Each LSTM layer maintains internal cell states and hidden states to capture long-range dependencies in expenditure patterns. In another embodiment, the server uses a transformer-based sequence model, including multiple attention layers that compute attention weights over prior time steps for each expenditure category. The server defines a loss function, for example a mean squared error between predicted expenditures and actual expenditures, and performs training by iteratively updating network weights using a gradient-based optimization algorithm such as stochastic gradient descent or an adaptive moment estimation algorithm. The server stores trained model parameters as expenditure tendency learning information for each user or for groups of users.

The server is configured to generate expenditure prediction information by executing the trained neural network model in an inference mode. The server loads a user's recent expenditure history, normalizes it with stored scaling parameters, and applies the trained model to compute predicted expenditures per category for future time periods. The server then denormalizes the model output to obtain actual currency units. By executing the neural network on vectorized data structures and optimized linear algebra kernels, the server reduces computation time compared to manual or rule-based projections, and the network's internal representation of complex temporal patterns improves prediction accuracy beyond simple linear extrapolations.

The server is configured to compute reduction requirement information and saving candidate information. The server compares predicted expenditures against stored budget information and target saving information. For each category and time period, the server calculates a difference between predicted expenditures and budget values. When the predicted expenditures exceed a budget or when the sum of expenditures leads to an expected deficit relative to the target saving information, the server computes a required reduction amount. The server then executes an optimization routine, which may include a greedy algorithm or a constrained linear optimization, to assign reduction amounts to different expenditure categories under constraints such as non-negativity and maximum feasible reduction per category. From this optimization, the server derives saving candidate categories and saving effect amounts, representing a set of possible reductions that fulfill the target saving information while minimizing disruption based on historical elasticity of each category.

The server is further configured to analyze emotion-related information. The terminal acquires emotion-related information from the user, for example text messages, voice input captured by a microphone, or images captured by a camera. The terminal sends the emotion-related information to the server. The server executes a natural language processing module to perform sentiment classification on text, using a pre-trained text classification neural network that assigns probability scores to labels such as “anxious,” “confident,” and “confused.” For voice signals, the server or the terminal extracts acoustic features such as pitch, energy, and spectral coefficients, and the server feeds these features into a trained deep neural network classifier. For facial images, the server executes a convolutional neural network that has been trained to distinguish facial expressions corresponding to basic emotions. The server fuses these modality-specific outputs, for example by weighted averaging of probabilities, to determine emotion state information. The server then records sequences of emotion state labels over time and applies a temporal analysis algorithm, such as hidden Markov modeling or temporal aggregation, to derive emotion tendency information.

The server is configured to generate structured information that combines the output of the expenditure prediction, saving candidate computation, and emotion analysis. The server constructs a composite data structure that includes, for example, a list of expenditure categories, recent and predicted expenditures for each category, corresponding budget values, saving candidate categories, saving effect amounts, the user's target saving information, and the current emotion state information. The server orders this structured information in a standardized, machine-readable template that is used to construct a prompt sentence.

The server is configured to generate a prompt sentence as an instruction string for a generative AI model. The server converts the structured information into textual content by combining fixed template phrases with dynamically inserted values. The server includes in the prompt sentence a role description for the generative AI model, contextual information about the user, and specific instructions on the format and tone of the desired saving proposal response. For example, the server generates a prompt sentence such as:

“You are a financial advisor. The user's goal is to save 500,000 yen in the next 12 months. Based on the following spending history and forecast data, identify concrete savings actions for each category, specify monthly and yearly savings amounts, and explain the reasoning in simple terms.”

In another example, when the emotion state information indicates confusion, the server generates a prompt sentence such as:

“The user is currently feeling confused about their finances. Provide empathetic, stress-reducing advice, avoid technical jargon, and give step-by-step, easy-to-follow actions.”

The server appends to these instructions a representation of the structured information, expressed as human-readable sentences or lists rather than as raw numerical tables. The prompt sentence thus encodes not only data, but also processing directives that instruct the generative AI model to focus on categories with high saving potential and to adapt explanation depth to the user's emotional state. By encoding model directives and structured context into a single prompt sentence, the server reduces the need for multiple back-and-forth calls to the generative AI model and reduces communication load.

The server is configured to execute the generative AI model by sending the prompt sentence to a language model runtime. The generative AI model is realized, for example, as a transformer-based neural network that has been pre-trained on large-scale text data and optionally fine-tuned on financial advisory documents. The model comprises multiple attention layers, feed-forward layers, and normalization layers that transform input token sequences into output token sequences. The server tokenizes the prompt sentence, feeds the token sequence into the model, and obtains a generated token sequence as the saving proposal response. The server then detokenizes the output sequence into natural language text. Because the prompt sentence already contains structured and filtered information, the model can generate an answer in a single pass that is tightly aligned with the user's financial situation, thereby improving response consistency and reducing inference time compared to systems that rely on generic prompts and external post-processing.

The server is configured to process the saving proposal response to extract concrete action plans and numerical effect information. The server may execute a post-processing module that parses the output text to identify references to expenditure categories and amounts. The server may apply pattern-matching rules or a secondary classifier to detect numeric expressions and associate them with specific actions, such as “reduce coffee shop visits to twice per week” or “limit monthly entertainment spending to 10,000 yen.” The server then cross-checks these amounts with the previously computed saving effect amounts and, if necessary, adjusts values to maintain internal consistency. The server packages the resulting action plans and effect estimates as notification information, along with explanatory text and priority flags.

The server is configured to transmit the notification information to the terminal. The terminal receives the notification information and renders immediate notification information, such as a pop-up alert, and detailed explanation information, such as a full advice screen showing a list of recommended changes and the expected savings. The terminal may display charts summarizing the impact of following the proposed actions on future expenditures and target savings. By delegating heavy computation and model execution to the server and limiting the terminal to rendering and input capture, the system improves energy efficiency on the terminal and allows multiple terminals to share the same trained models.

The server is configured to acquire response information and behavior history information from the user. The user may indicate through the terminal whether a particular saving proposal is accepted, rejected, or postponed. The user may also perform actions, such as modifying category limits or manually recording reduced expenditures. The terminal sends these signals to the server. The server correlates response information with specific saving candidate categories and concrete action plans and records the outcome as behavior history information. The server then periodically uses this information to perform a learning update. For example, the server can re-estimate which categories are realistically reducible, adjust weights in the expenditure tendency learning models to reflect observed behavioral elasticity, and update emotion tendency models to capture how user emotions change after following or ignoring advice. By incorporating actual behavioral feedback, the server mitigates model drift and improves the quality of future expenditure predictions and saving candidate information.

The server thereby improves computer technology rather than merely automating human judgment. The use of normalized structured representations, neural network-based pattern learning, emotion-aware prompt construction, and behavior-based model updates reduces redundant computation, improves cache efficiency, lowers the number of external generative AI model calls, and increases prediction accuracy. The server implements a non-conventional data-processing pipeline that integrates multiple technical modules time-series normalization, high-dimensional feature extraction, deep neural sequence modeling, prompt sentence synthesis, and post-generation extraction into a single coherent feedback loop. This structure yields lower latency for generating advice, improved accuracy of forecasts and recommendations, and reduced network traffic between the server and the generative AI model host.

In alternative embodiments, the server may use different neural network architectures, such as gated recurrent units instead of LSTM units, or dilated convolutional sequence models instead of transformers. The server may adjust the feature set used for expenditure tendency learning, such as including additional features derived from merchant categories or transaction frequency. The server may perform emotion analysis entirely on the terminal and send only low-dimensional emotion state information to the server, thereby reducing bandwidth usage. The server may implement the prompt sentence generation using different templates tailored for different user profiles. The server may host the generative AI model locally or access it via a remote inference service, provided that the structured prompt sentence is transmitted to the model and that the saving proposal response is returned in a processable format.

In another embodiment, the terminal may execute part of the normalization and aggregation operations for improved scalability. For example, the terminal may pre-aggregate expenditures per category per day and send only summarized data to the server. The server still performs the time-series learning and generative prompting as described but on a more compact data set, reducing storage and computation requirements without sacrificing the technical improvements in prediction and recommendation.

Through these embodiments, the server, the terminal, and the user cooperate to implement the claimed system in a manner that a person skilled in the art can reproduce. The described hardware components, software modules, data structures, neural network architectures, and processing flows provide a concrete and technical realization of a system that uses a generative AI model driven by carefully constructed prompt sentences, coupled with expenditure and emotion learning, to efficiently generate, refine, and present saving proposals with improved computational performance.

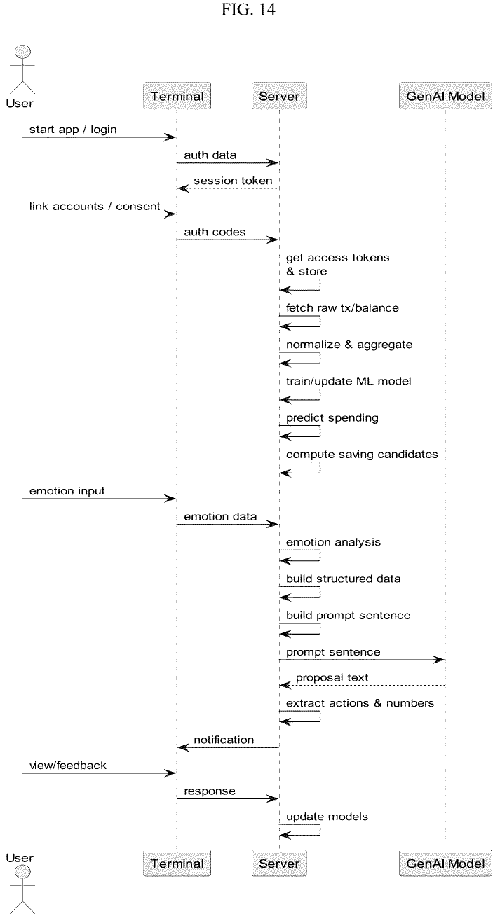

The following describes the processing flow using FIG. 14.

### Step 1

User operates the terminal to start a financial advisory session.

User provides authentication information (such as an identifier and a password or biometric data) as input through the terminal's user interface.

Terminal generates a login request message including the authentication information and sends this message to the server via a secure communication channel.

Server receives the login request as input, verifies the authentication information against stored account records in an information storage device, and, if valid, generates a session token as output.

Server sends the session token to the terminal, and terminal stores the session token in a secure memory area for subsequent requests.

### Step 2

User operates the terminal to register or update links to external financial accounts.

User selects financial institutions and authorizes access via an authorization screen displayed on the terminal.

Terminal receives authorization codes from external institutions as input, packages the codes with the user identifier, and transmits this data to the server.

Server receives the authorization codes as input, exchanges the authorization codes for access tokens by calling external institution application interfaces, and receives access tokens as output from the external institutions.

Server encrypts and stores the access tokens in an account linkage table in the information storage device as output of this step.

### Step 3

Server periodically initiates acquisition of financial trend information.

Server reads stored access tokens and user identifiers as input and sends requests to external institution interfaces to obtain transaction history information and balance information.

Server receives, as input from the external institutions, raw transaction records and balance records, typically in a structured text format containing transaction dates, amounts, merchant identifiers, and provisional categories.

Server parses the received data, validates record formats, and inserts or updates the raw data into transaction and balance tables in the information storage device as output of this step.

### Step 4

Server executes a normalization routine to produce organized information.

Server reads raw transaction history information from the transaction table as input, including transaction dates, amounts, merchant names, and any existing category labels.

Server converts date strings into standardized timestamp objects, converts currency values into a normalized numeric type, and maps merchant names to normalized expenditure categories using a mapping table as data processing.

Server detects duplicate or inconsistent records using key comparisons and statistical thresholds and removes or flags them as part of the data processing.

Server writes the resulting cleaned and standardized records as organized information back into a normalized transaction table or a separate organized data table as output.

### Step 5

Server generates aggregated expenditure features for machine learning.

Server reads organized information as input, including transaction amounts, timestamps, and normalized categories for each user.

Server groups transactions by user, expenditure category, and time period (such as day, week, or month), and computes aggregated values such as total amount, average amount, and variance as data operations.

Server produces time-series feature vectors per period and per user, containing at least one value per expenditure category and additional temporal indicators, and stores these feature vectors in a summary table as output.

### Step 6

Server constructs training input information and trains a machine learning model.

Server takes aggregated feature vectors and corresponding actual expenditures as input for several historical periods for each user or for a cohort of users.

Server normalizes each feature dimension by subtracting mean values and dividing by standard deviation, creating scaled sequences as training input information.

Server feeds these sequences as input into a neural network implemented in a machine learning framework, such as a recurrent neural network or transformer-based sequence model, and computes predicted expenditures for training periods as intermediate output.

Server computes a loss value, for example a mean squared error between predicted expenditures and actual expenditures, and performs backpropagation and weight updates using a gradient-based optimization algorithm based on the computed loss.

Server repeats this process for multiple epochs until convergence criteria are met, then stores the trained model parameters as expenditure tendency learning information as output.

### Step 7

Server generates expenditure prediction information using the trained model.

Server reads the most recent aggregated feature vectors for a user as input, including normalized expenditures and temporal features for recent periods.

Server normalizes the input features using the stored scaling parameters and feeds the normalized vectors into the trained neural network model in inference mode.

Server receives predicted expenditures for future periods and categories as output from the model, then reverses the normalization process to convert predictions into actual currency units.

Server stores these predicted values, as expenditure prediction information, in a forecast table as output.

### Step 8

Server computes reduction requirement information based on budgets and target saving information.

Server reads expenditure prediction information, budget information, and target saving information associated with the user as input.

Server calculates, for each period and expenditure category, the difference between predicted expenditures and budget amounts, and also calculates the expected savings shortfall relative to the target saving information as data operations.

Server determines, as reduction requirement information, one or more required reduction amounts across categories and time periods to remove or reduce the shortfall.

Server records the reduction requirement information in a reduction table as output.

### Step 9

Server generates saving candidate information.

Server reads reduction requirement information, historical expenditure patterns, and category-specific constraints as input.

Server executes an allocation algorithm that distributes the required reduction amounts among multiple expenditure categories, for example by prioritizing categories with higher historical flexibility or lower essentiality.

Server computes, as data operations, saving candidate categories and saving effect amounts, such as estimated monthly and yearly savings per category if the recommended reductions are applied.

Server stores saving candidate information in a structured format in a saving candidate table as output.

### Step 10

Terminal acquires emotion-related information from the user.

User inputs a free-text message, or speaks into a microphone, or allows capture of facial images by the camera while interacting with the terminal.

Terminal captures and digitizes the input as emotion-related information, such as text strings, audio signals, or image frames, as input of this step.

Terminal may perform local preprocessing, such as noise filtering for audio or face detection for images, and sends the processed emotion-related information to the server as output of this step.

### Step 11

Server performs emotion analysis.

Server receives emotion-related information from the terminal as input and classifies the information to determine an emotion state.

Server applies, depending on the modality, a text sentiment classifier, a speech emotion classifier, or an image-based facial expression classifier implemented in a machine learning framework, and computes probability values for a set of emotion labels.

Server selects the label with the highest probability or a combination of labels exceeding a threshold as emotion state information and logs sequences of such labels over time to derive emotion tendency information by temporal aggregation or pattern detection.

Server stores emotion state information and emotion tendency information in an emotion history table as output.

### Step 12

Server constructs structured information combining financial and emotion data.

Server reads saving candidate information, expenditure prediction information, target saving information, and emotion state information as input.

Server assembles these data items into a unified structured representation, assigning each item to a specific field or section, including category-level recommended reductions, forecasted expenditures, savings goals, and current user emotion.

Server serializes this representation into an intermediate format suitable for embedding into text, such as a list of sentences or key-value pairs, and stores it as structured information as output.

### Step 13

Server generates a prompt sentence for a generative AI model.

Server uses the structured information as input and applies a template engine to combine fixed instruction phrases with dynamic content.

Server inserts data such as saving candidate categories, saving effect amounts, the user's target saving information, and the detected emotion state into a pre-defined textual template, forming a coherent instruction string.

Server generates, as output, a prompt sentence that instructs the generative AI model to behave as a financial advisor, to consider the provided financial and emotion context, and to produce a saving proposal response in a specified style and level of detail.

### Step 14

Server invokes the generative AI model using the prompt sentence.

Server tokenizes the prompt sentence into input tokens and sends the token sequence as input to a generative AI model runtime hosted locally or remotely.

Server receives from the generative AI model a sequence of output tokens representing the generated saving proposal response as output of the model.

Server detokenizes the output tokens into a natural language text response and stores the saving proposal response in association with the corresponding prompt sentence as output of this step.

### Step 15

Server extracts concrete action plans and numerical effect information.

Server uses the saving proposal response as input and applies a post-processing module to identify key segments describing proposed actions and associated numeric values.

Server parses the text to detect references to expenditure categories, frequency of actions (such as weekly or monthly), and monetary values, using pattern matching and named-entity recognition as data operations.

Server aligns the extracted actions with saving candidate categories and verifies or adjusts the amounts to ensure consistency with previously computed saving effect amounts.

Server generates notification information that includes explicit action descriptions and confirmed numerical effect information as output.

### Step 16

Server delivers notification information to the terminal.

Server takes notification information and a user identifier as input and constructs one or more messages suitable for the terminal's user interface, such as short alerts and detailed recommendations.

Server transmits the messages to the terminal over the network as output of this step.

Terminal receives the messages as input, stores them temporarily, and renders immediate notification information, such as pop-up alerts, and detailed explanation information, such as advice screens with lists and charts, on the display as output.

### Step 17

User reviews and responds to the presented advice.

User reads the immediate notification information and detailed explanation information on the terminal and decides whether to follow, postpone, or reject the proposed actions.

User interacts with the terminal to indicate choices, for example by selecting “accept,” “reject,” or “remind later” buttons, or by entering follow-up questions.

Terminal collects these user inputs as response information and sends them to the server as output of this step.

### Step 18

Server updates learning information based on response information and behavior history information.

Server receives response information from the terminal as input and correlates it with the underlying saving candidate categories and action plans.

Server records, as behavior history information, whether each proposed action was accepted or rejected and monitors subsequent transaction data over time to detect whether the user's actual expenditures changed in the recommended categories.

Server uses this combined input response information and behavior history information to adjust parameters in the expenditure tendency learning models and emotion tendency models, for example by increasing weights for categories that the user frequently adjusts and decreasing assumed reducibility for ignored categories.

Server stores updated expenditure tendency learning information and updated emotion tendency information as output, thereby refining future expenditure predictions and improving the generation of prompt sentences and saving proposal responses.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

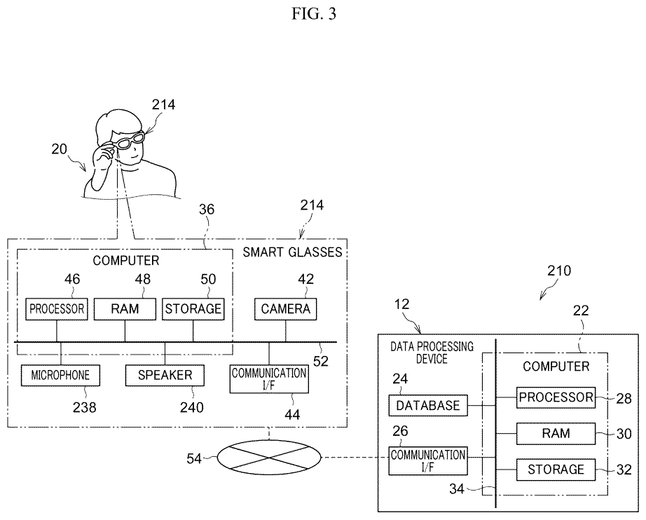

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

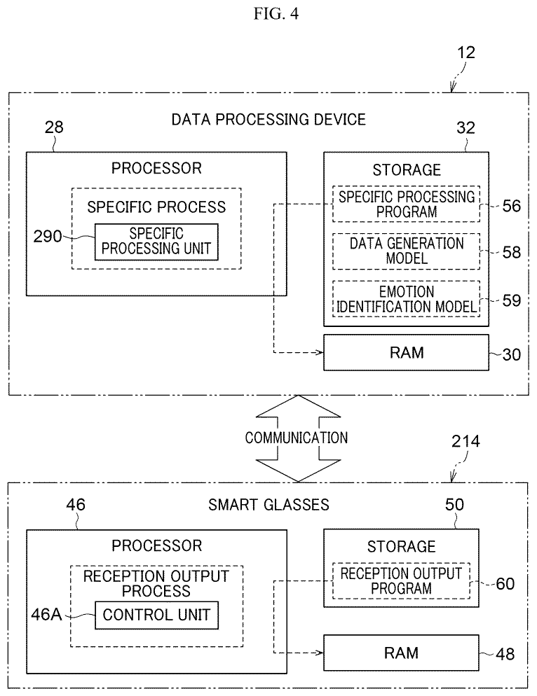

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

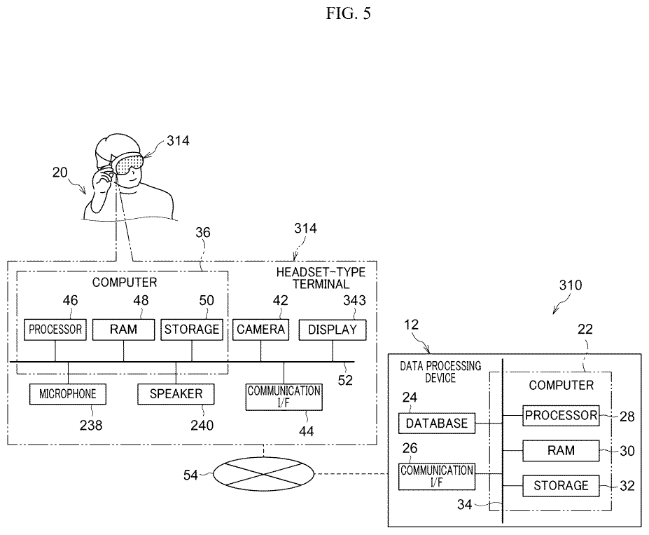

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

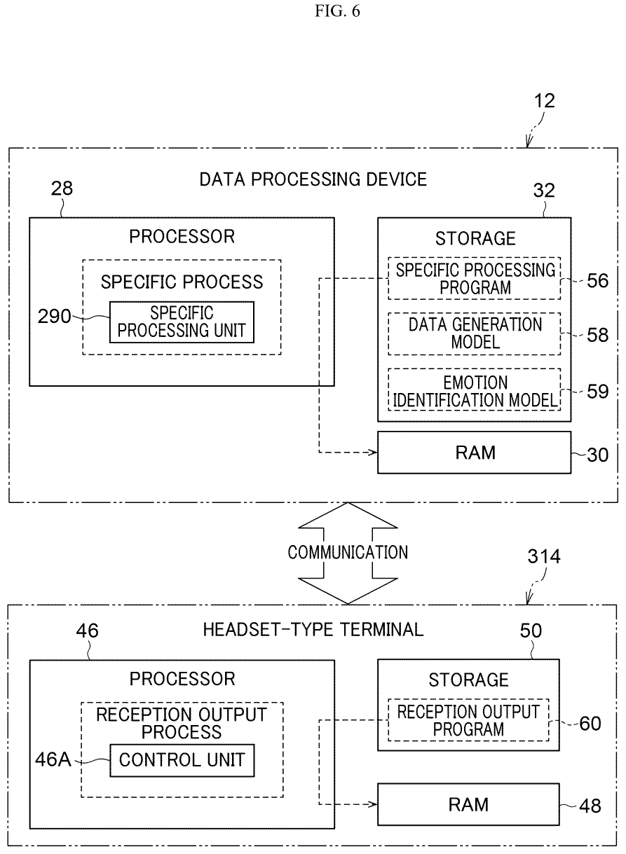

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

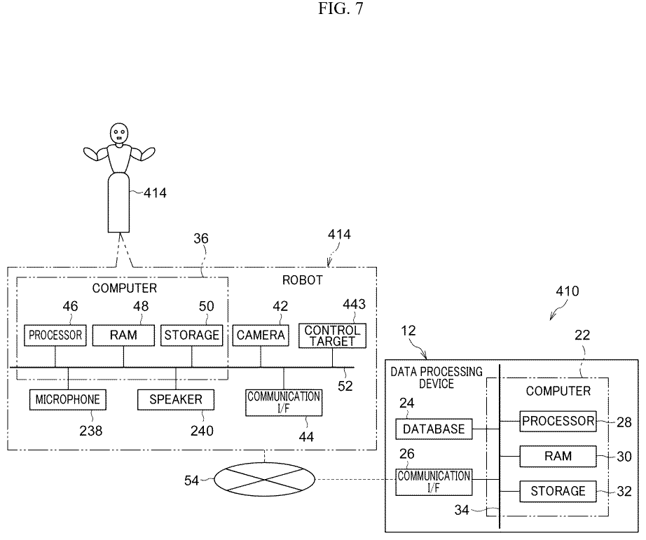

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

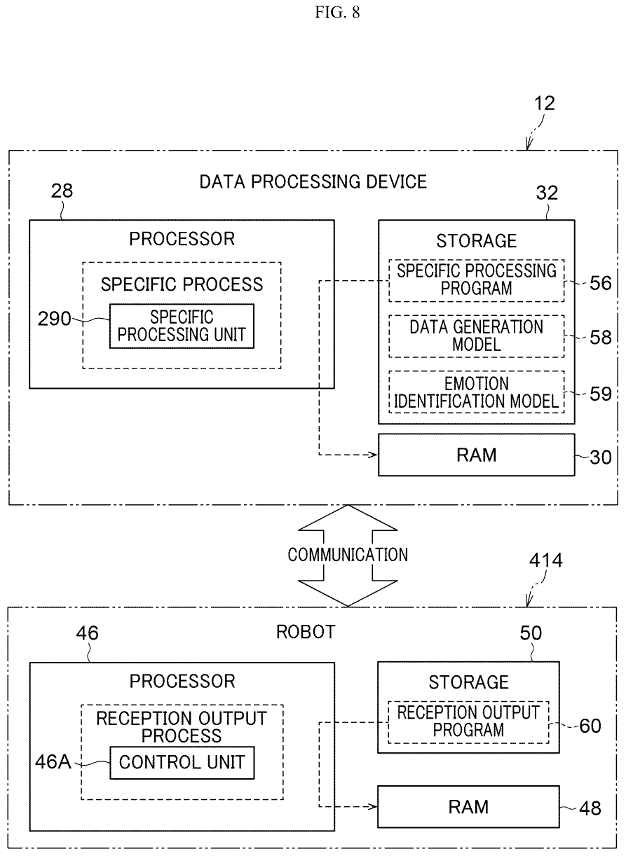

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

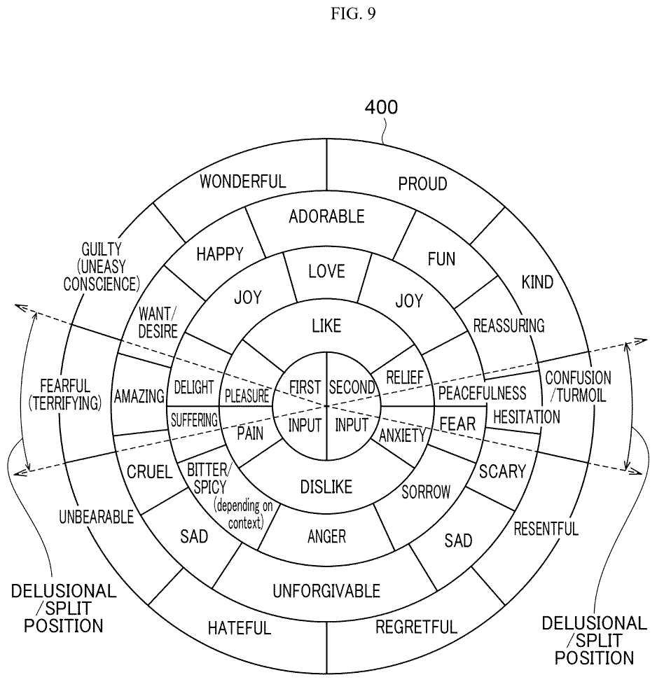

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

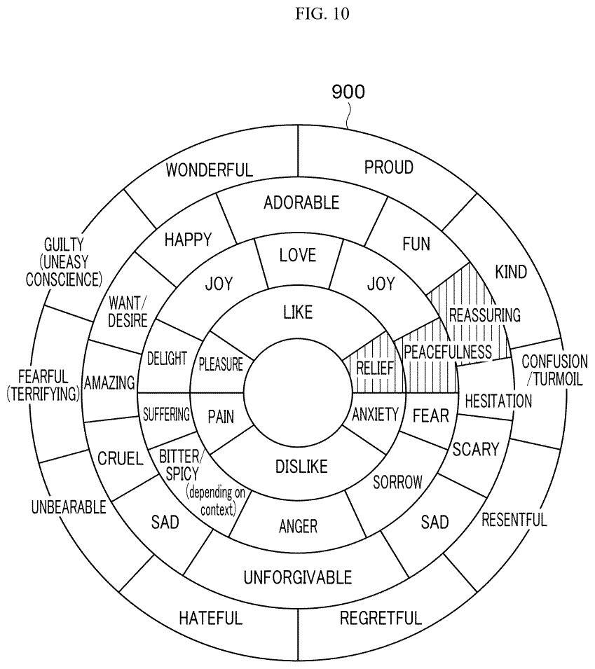

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage device,
wherein the processor is configured to
receive, from a terminal operated by a user, input information expressed in natural language and including a question regarding financial matters, and analyze the input information to extract an intention of the user and financial-related elements including at least one of an investment purpose, a time horizon, or a risk preference, by using a natural language processing function,
access the storage device that stores structured financial attribute information associated with an identifier of the user, and acquire, based on the identifier, the financial attribute information including at least one of income information, asset information, liability information, investment experience information, surplus fund information, or risk tolerance information,
generate a prompt sentence by combining the extracted intention and financial-related elements, the acquired financial attribute information, and constraint conditions regarding at least one of an answer format, a level of explanation, or a description of risk, and prepare the prompt sentence as input data for a generative AI model,
transmit the generated prompt sentence to an internal or external generative AI model, cause the generative AI model to perform numerical computation based on the prompt sentence to generate answer information in a text format, and acquire the generated answer information as response data,
add, to the acquired answer information, predetermined cautionary text or disclaimer text and perform formatting of the answer information into output information suitable for presentation to the user, and
transmit the formatted output information to the terminal via a communication network so that the terminal displays the output information to the user.

### Supplementary 2

The system according to supplementary 1,
wherein the processor is configured to
refer to stored rule information or evaluation criterion information representing expert knowledge, and, based on the rule information or the evaluation criterion information, select or adjust at least one of a type of financial product, an item for explanation of a risk level, or a viewpoint for comparison to be included in the prompt sentence, so that expert knowledge is reflected in generation of the prompt sentence and in generation of the answer information.

### Supplementary 3

The system according to supplementary 1,
wherein the processor is configured to
calculate at least one of a saving ratio, a debt repayment burden, an asset allocation status, or an investment risk level based on the acquired financial attribute information and the acquired answer information, generate proposal information relating to financial management including at least one of a household budget improvement policy, an expenditure reduction policy, or an asset allocation policy according to a result of the calculation, and cause the proposal information to be included in the output information transmitted to the terminal.

### Application Example 1

### Supplementary 1

A system comprising a processor,
wherein the processor is configured to
store, in a storage unit, financial information and target information acquired from a user via an operation terminal, and perform data processing to aggregate inflow and outflow information included in the financial information by period and by category so as to calculate surplus funds and a saving amount required to achieve a target, and
generate a prompt sentence for input to a generative AI model by embedding, into natural language text, the surplus funds, a target saving amount, a target period, user attribute information, and expenditure category information calculated or obtained by the data processing, and
input the prompt sentence into the generative AI model and obtain response information including an investment plan and expenditure reduction proposals based on a text generation process executed by the generative AI model, and
analyze the response information to extract asset allocation information, risk level information, and expenditure reduction item information, and convert the extracted information into structured data that is output in a format presentable to the operation terminal.

### Supplementary 2

The system according to supplementary 1,
wherein the processor is configured to
inspect the response information obtained from the generative AI model in accordance with evaluation rules or guidelines defined based on expert knowledge, and to correct or cause regeneration of the response information that does not conform to the evaluation rules or guidelines.

### Supplementary 3

The system according to supplementary 1,
wherein the processor is configured to
calculate, from the financial information, monthly aggregate values for each expenditure category, and
generate, in the prompt sentence, simulation conditions for expenditure reduction based on the monthly aggregate values for each expenditure category, and
cause the generative AI model to generate proposals related to financial management in accordance with the simulation conditions.

### Example 2

### Supplementary 1

A system comprising a processor and a storage device,
wherein the processor is configured to
acquire authentication information from a user terminal, access a communication interface of an external information providing device using the authentication information, obtain time-series information including financial transaction information of a user via the communication interface, and store the obtained time-series information in the storage device,
perform preprocessing on the time-series information stored in the storage device using a general-purpose information processing program, the preprocessing including completion of missing values, removal of abnormal values, normalization of attribute information, aggregation for each time unit, and extraction of feature values for each expenditure category, and generate training data that is learnable by a generative AI model,
operate the generative AI model constructed on a machine learning framework using the training data as input, generate pattern information representing an expenditure tendency for each user and prediction information indicating a future expenditure amount, and store the pattern information and the prediction information as structured data in the storage device,
generate a prompt sentence to be input to the generative AI model by dynamically generating the prompt sentence in accordance with a template based on structured data including the pattern information, the prediction information, and target information set by the user, and
embed the structured data in the prompt sentence so as to generate the prompt sentence for instructing generation of a saving proposal or a budget proposal related to financial management of the user,
call the generative AI model using the prompt sentence as input, obtain proposal information in natural language output from the generative AI model, and store the proposal information as management information including target value information for each expenditure category of the user in the storage device,
transmit the proposal information and the target value information stored in the storage device to the user terminal via a communication network and provide the proposal information and the target value information as notification information in a displayable format on the user terminal, and
acquire evaluation information or feedback information regarding the proposal information from the user terminal and update at least one of a generation condition of the prompt sentence and a learning condition of the generative AI model based on the evaluation information or the feedback information.

### Supplementary 2

The system according to supplementary 1,
wherein the processor is configured to store supervision information of an evaluator having expert knowledge as rule information or weight information in the storage device in generation of the prompt sentence, correct components and output constraint conditions of the prompt sentence based on the supervision information, and control the generation condition of the prompt sentence so as to reflect the expert knowledge in the proposal information by the generative AI model.

### Supplementary 3

The system according to supplementary 1,
wherein the processor is configured to generate a financial management proposal including a plurality of alternatives for improving financial management of the user based on the pattern information representing the expenditure tendency and the prediction information indicating the future expenditure amount, calculate an achievability index and a predicted reduction amount index for each of the plurality of alternatives, and control at least one of content and priority of the proposal information presented to the user based on the achievability index and the predicted reduction amount index.

### Application Example 2

### Supplementary 1

A system comprising a processor,
wherein the processor is configured to
perform natural language processing to analyze inquiry information received from a user, and
access an information storage device to acquire financial trend information of the user, and
manage authentication information for acquiring the financial trend information via a communication function with an external institution and acquire, as the financial trend information, transaction history information and balance information, and
normalize the acquired transaction history information on the basis of time-series information and classification information, perform completion of missing information and removal of abnormal information, and store the normalized transaction history information as organized information, and
calculate past expenditure tendencies for a plurality of expenditure categories by using the organized information and generate expenditure tendency learning information by inputting the organized information as training input information to a machine learning algorithm, and
generate expenditure prediction information for a future period on the basis of the expenditure tendency learning information, compare the expenditure prediction information with budget information and target saving information, determine a possibility of exceeding at least one of the budget information and the target saving information, and calculate reduction requirement information, and
store the target saving information and expenditure constraint information received from the user, and calculate, as saving candidate information, saving candidate categories and saving effect amounts by combining the expenditure prediction information and the reduction requirement information, and
analyze emotion-related information acquired from the user and generate emotion state information and emotion tendency information as emotion analysis information, and
generate structured information including the saving candidate information, the expenditure prediction information, the target saving information, and the emotion state information, and
generate a prompt sentence for causing a generative AI model to generate a saving proposal response on the basis of the structured information, and
input the prompt sentence to the generative AI model, acquire the saving proposal response generated by the generative AI model, extract, from the saving proposal response, concrete action plans and numerical effect information, and generate notification information, and
transmit the notification information to a user information terminal and cause the user information terminal to present the notification information as immediate notification information and detailed explanation information, and
acquire response information and behavior history information from the user and update at least one of the expenditure tendency learning information and the emotion tendency information on the basis of the response information and the behavior history information.

### Supplementary 2

The system according to supplementary 1,
wherein the processor is configured to
estimate the emotion state information on the basis of at least one of voice information, image information, and character information included in the emotion-related information, and
generate the prompt sentence including instruction information for optimizing contents of the saving proposal response by changing, in accordance with the emotion state information, at least one of a representation style and a level of detail of explanation.

### Supplementary 3

The system according to supplementary 1,
wherein the processor is configured to
specify periodic expenditure periods and emotion fluctuation periods on the basis of the expenditure tendency learning information and the emotion tendency information, and
cause the generative AI model to generate preventive advice information and action plan information for a future specific period by including a result of the specifying in the prompt sentence.

What is claimed is:

1. A system comprising:
circuitry configured to:
receive, from a terminal device via a packet-switched network, input data expressed in natural language and including a query from a user, and analyze the input data by using a natural language processing function to extract an intention of the user and domain-related elements;
access a storage device that stores structured attribute information associated with an identifier of the user, and acquire, based on the identifier, the attribute information;
generate a prompt sentence by combining the extracted intention and domain-related elements, the acquired attribute information, and constraint conditions regarding at least one of an answer format, a level of explanation, or a description of limitations, and prepare the prompt sentence as input data for a generative neural network model;
transmit the prompt sentence to the generative neural network model, cause the generative neural network model to perform inference processing based on the prompt sentence to generate answer data in a text format, and acquire the generated answer data as response data;
add, to the acquired answer data, predetermined supplemental text and perform formatting of the answer data into output data suitable for presentation to the user; and
transmit the formatted output data to the terminal device via the packet-switched network so that the terminal device displays the output data to the user.

2. The system according to claim 1, wherein the circuitry is configured to refer to stored rule information or evaluation criterion information representing domain knowledge, and, based on the rule information or the evaluation criterion information, select or adjust at least one of a type of item, an item for explanation, or a viewpoint for comparison to be included in the prompt sentence.

3. The system according to claim 2, wherein the circuitry is configured to calculate at least one of a ratio, a burden level, an allocation status, or a risk level based on the acquired attribute information and the answer data, generate proposal information according to a result of the calculation, and cause the proposal information to be included in the output data.

4. The system according to claim 3, wherein the circuitry is configured to aggregate inflow and outflow information included in the attribute information by period and by category to compute summary values, and embed the summary values, target parameters, user attribute information, and category information into the prompt sentence.

5. The system according to claim 4, wherein the circuitry is configured to generate a plurality of scenario-based prompt sentences each reflecting different parameter assumptions, transmit each scenario-based prompt sentence to the generative neural network model, and present comparative scenario results to the terminal device.

6. The system according to claim 5, wherein the circuitry is configured to store the scenario results in the storage device, associate the scenario results with the user identifier, and retrieve the scenario results in response to subsequent queries from the terminal device.

7. The system according to claim 1, wherein the circuitry is configured to perform tokenization, part-of-speech tagging, and semantic analysis on the input data to extract the intention and the domain-related elements, and compute a confidence score for each extracted element.

8. The system according to claim 7, wherein the generative neural network model comprises a transformer architecture including an embedding layer, a plurality of self-attention layers, and an output layer configured to produce a probability distribution over a token vocabulary.

9. The system according to claim 8, wherein the circuitry is configured to set inference parameters for the generative neural network model including a temperature value, a sampling threshold, and a maximum output token count so as to control precision and length of the answer data.

10. The system according to claim 9, wherein the circuitry is configured to apply constrained decoding to the output of the generative neural network model in which generated tokens are validated against a vocabulary of domain terms stored in the storage device.

11. The system according to claim 1, wherein the circuitry is configured to store, in the storage device, a correspondence between the prompt sentence and the answer data as history information, and adjust at least one of contents of the prompt sentence or parameters of the natural language processing function based on the stored history information.

12. The system according to claim 11, wherein the circuitry is configured to maintain a dialogue session with the terminal device, accumulate successive input data within the dialogue session, and append context information from prior interactions to the prompt sentence.

13. The system according to claim 12, wherein the circuitry is configured to detect a change in the intention across successive interactions within the dialogue session and adjust the prompt sentence to reflect the changed intention.

14. The system according to claim 1, wherein the circuitry is configured to analyze the input data using an emotion estimation model to determine an emotional state of the user, and adjust at least one of a tone or a level of detail of the prompt sentence based on the estimated emotional state.

15. The system according to claim 14, wherein the circuitry is configured to adjust a presentation format of the output data transmitted to the terminal device based on the estimated emotional state.

16. The system according to claim 1, wherein the circuitry is configured to convert the answer data into audio data by using a speech synthesis function and transmit the audio data to the terminal device via the packet-switched network.

17. The system according to claim 16, wherein the circuitry is configured to generate a virtual character video synchronized with the audio data using a character generation function and transmit the virtual character video to the terminal device.

18. A system comprising:
circuitry configured to:
receive, from a terminal device via a packet-switched network, input data expressed in natural language including a query, and analyze the input data by using a natural language processing function including tokenization, part-of-speech tagging, and semantic analysis to extract an intention and domain-related elements with associated confidence scores;
access a storage device storing structured attribute information associated with a user identifier, and acquire the attribute information;
generate a prompt sentence by combining the extracted intention, the domain-related elements, the attribute information, and constraint conditions, and configure the prompt sentence for input to a generative neural network model comprising a transformer architecture with self-attention layers;
transmit the prompt sentence to the generative neural network model to generate answer data, add supplemental text to the answer data, and format the answer data into output data;
refer to stored rule information representing domain knowledge to adjust contents included in the prompt sentence; and
transmit the formatted output data to the terminal device via the packet-switched network.

19. The system according to claim 18, wherein the circuitry is configured to calculate at least one of a ratio, a burden level, or an allocation status based on the attribute information and the answer data, generate proposal information according to the calculation, and include the proposal information in the output data.

20. A method comprising:
receiving, by circuitry from a terminal device via a packet-switched network, input data expressed in natural language and including a query from a user, and analyzing the input data by using a natural language processing function to extract an intention of the user and domain-related elements;
accessing a storage device that stores structured attribute information associated with an identifier of the user, and acquiring, based on the identifier, the attribute information;
generating a prompt sentence by combining the extracted intention and domain-related elements, the acquired attribute information, and constraint conditions regarding at least one of an answer format, a level of explanation, or a description of limitations, and preparing the prompt sentence as input data for a generative neural network model;
transmitting the prompt sentence to the generative neural network model, causing the generative neural network model to perform inference processing based on the prompt sentence to generate answer data in a text format, and acquiring the generated answer data as response data;
adding, to the acquired answer data, predetermined supplemental text and performing formatting of the answer data into output data suitable for presentation to the user; and
transmitting the formatted output data to the terminal device via the packet-switched network.
